(19) United States
(12) Patent Application Publication
(10) Pub. No.: US 2013/0239415 A1
(43) Pub. Date: Sep. 19, 2013

(54) UTILITY KNIFE

(71) Applicant: MILWAUKEE ELECTRIC TOOL CORPORATION, Brookfield, WI (US)

(72) Inventor: Andrew G. Wagner, Lisbon, WI (US)

(73) Assignee: Milwaukee Electric Tool Corporation, Brookfield, WI (US)

(21) Appl. No.: 13/744,710

(22) Filed: Jan. 18, 2013

Related U.S. Application Data
(60) Provisional application No. 61/610,144, filed on Mar. 13, 2012.
(60) Provisional application No. 61/656,196, filed on Jun. 6, 2012.

(51) Int. Cl. B26B 1/08

(52) U.S. Cl. CPC B26B 1/08
USPC 30/162

(57) ABSTRACT

A utility knife includes a frame defining a track and a blade carrier slidably received within the track. A blade is removably coupled to the blade carrier, and an actuator is operably coupled to the blade carrier to facilitate movement of the blade carrier along the track between an extended position and a retracted position. The utility knife also includes a first handle portion coupled to the frame and a second handle portion coupled to the first handle portion. The second handle portion is pivotable with respect to the first handle portion and the frame between a first position allowing movement of the blade between the retracted position and the extended position and a second position inhibiting movement of the blade between the retracted position and the extended position.

### CROSS-REFERENCE TO RELATED APPLICATIONS

This application claims priority to co-pending U.S. Provisional Patent Application No. 61/610,144 filed on Mar. 13, 2012 and to co-pending U.S. Provisional Patent Application No. 61/656,196 filed on Jun. 6, 2012, the entire contents of which are incorporated herein by reference.

### FIELD OF THE INVENTION

The present invention relates to knives and more particularly to utility knives.

### BACKGROUND OF THE INVENTION

Utility knives typically include a housing, a blade carrier supported by the housing, and a blade coupled to the blade carrier for movement with the blade carrier between an extended position and a retracted position relative to the housing. During use, the blade may become dull or damaged. For some knives, this necessitates replacement of the entire blade. Other utility knives, often referred to as snap knives, incorporate a scored or segmented blade, allowing a user to break off the dull or damaged portion of the blade, to expose a new blade section for use.

### SUMMARY OF THE INVENTION

The invention provides, in one aspect, a utility knife. The utility knife includes a frame defining a track and a blade carrier slidably received within the track. A blade is removably coupled to the blade carrier, and an actuator is operably coupled to the blade carrier to facilitate movement of the blade carrier along the track between an extended position and a retracted position. The utility knife also includes a first handle portion coupled to the frame and a second handle portion coupled to the first handle portion. The second handle portion is pivotable with respect to the first handle portion and the frame between a first position allowing movement of the blade between the retracted position and the extended position and a second position inhibiting movement of the blade between the retracted position and the extended position.

The invention provides, in another aspect, a utility knife. The utility knife includes a frame defining a track and a blade carrier slidably received within the track. The blade carrier includes a threaded bore. The utility knife also includes a blade removably coupled to the blade carrier. A double-lead fastener is received within the threaded bore of the blade carrier, and the fastener is rotatable relative to the blade carrier between a first position allowing movement of the blade carrier along the track and a second position inhibiting movement of the blade carrier along the track.

Other features and aspects of the invention will become apparent by consideration of the following detailed description and accompanying drawings.

### BRIEF DESCRIPTION OF THE DRAWINGS

FIG. 1 is a perspective view of a utility knife according to one embodiment of the invention.

FIG. 2 is a perspective view of the utility knife of FIG. 1 with a first handle of the knife removed.

FIG. 3 is a perspective view of the utility knife of FIG. 1 with a second handle removed.

FIG. 4 is a perspective view of the utility knife of FIG. 1 with the first handle removed.

FIG. 5 is a perspective view of the utility knife of FIG. 1 with the first handle and a blade removed.

FIG. 6 is an end view of the utility knife of FIG. 1 with the first handle removed.

FIG. 7 is a side view of a portion of the utility knife of FIG. 1.

FIG. 8 is a cross-section view of the portion of the utility knife of FIG. 7 taken along lines 8-8 of FIG. 7.

FIG. 9 is a perspective view of a blade carrier of the utility knife if FIG. 1.

FIG. 10 is another perspective view of the blade carrier of FIG. 9.

FIG. 11 is a side view of the blade of the utility knife of FIG. 1.

FIG. 12 is a perspective view of a utility knife according to another embodiment.

FIG. 13 is an alternative perspective view of the knife of FIG. 12.

FIG. 14 is perspective view of the utility knife of FIG. 12 with a handle of the knife removed.

FIG. 15 is a side view of the knife of FIG. 12 with the handle removed.

FIG. 16 is a side view of a knife according to another embodiment.

FIG. 17 is a top view of the knife of FIG. 16.

FIG. 18 is a perspective view of the knife of FIG. 16 with a portion of the handle removed.

FIG. 19 is a perspective view of the knife of FIG. 16 with the handle removed.

FIG. 20 is a perspective view of the knife of FIG. 16 with portions of the knife removed.

FIG. 21 is a perspective view of a carrier of the knife of FIG. 16.

FIG. 22 is a perspective view of a knife according to another embodiment.

FIG. 23 is a perspective view of the knife of FIG. 22 with a handle removed.

FIG. 24 is a perspective view of an actuator of the knife of FIG. 22.

FIG. 25 is a perspective view of the actuator and a locking member of the knife of FIG. 22.

FIG. 26 is a perspective view of the knife of FIG. 22 with the handle removed.

FIG. 27 is a perspective view of a carrier and the locking member of the knife of FIG. 22.

FIG. 28 is an enlarged side view of the knife of FIG. 22 with the handle removed.

FIG. 29 is an alternative perspective view of the carrier and the locking member of the knife of FIG. 22.

FIG. 30 is a perspective view of a knife according to another embodiment of the invention.

FIG. 31 is a perspective view of the knife of FIG. 30 with a handle removed.

FIG. 32 is a cross-sectional view of the knife of FIG. 30 taken along lines 32-32 of FIG. 30.

FIG. 33 is an exploded view of a carrier and a locking assembly of the knife of FIG. 30.

FIG. 34 is a perspective view of the carrier and locking assembly of FIG. 33 assembled.

FIG. 35 is a perspective view of a knife according to another embodiment of the invention.

FIG. 36 is a perspective view of the knife of FIG. 35 with a handle removed.

FIG. 37 is a partially exploded perspective view of the knife of FIG. 35.

FIG. 38 is a side view of the knife of FIG. 35.

FIG. 39 is an enlarged, cross-sectional view of the knife of FIG. 35, taken along line 39-39 of FIG. 38.

FIG. 40 is a side view of a fastener of the knife of FIG. 35.

FIG. 41 is a rear perspective view of an actuator of the knife of FIG. 35.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

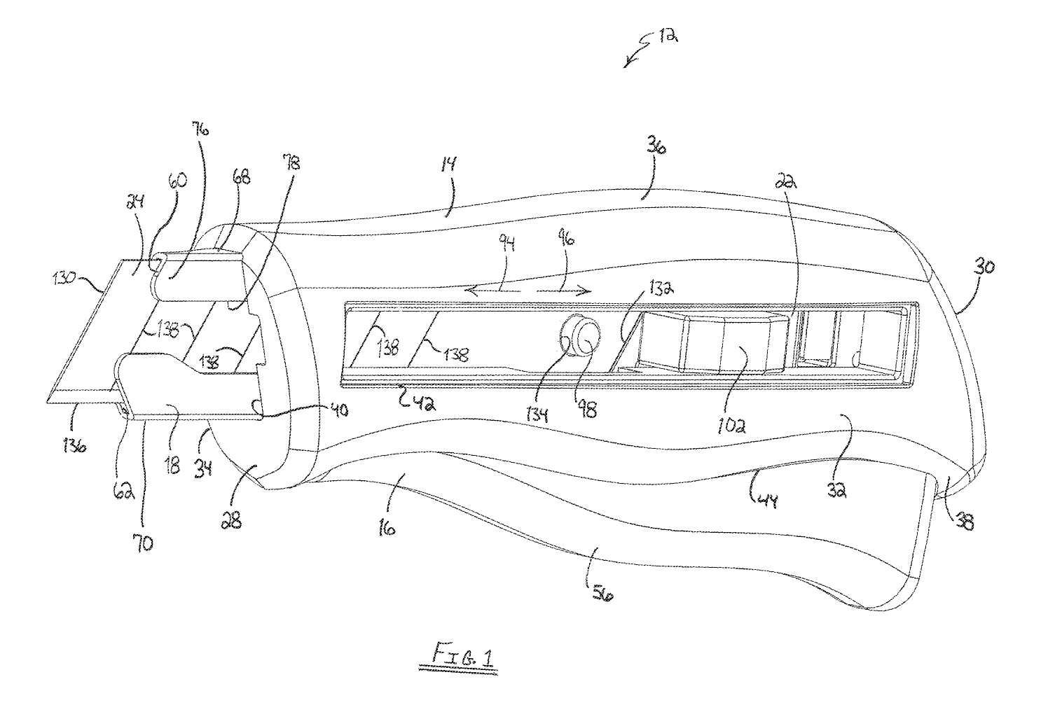

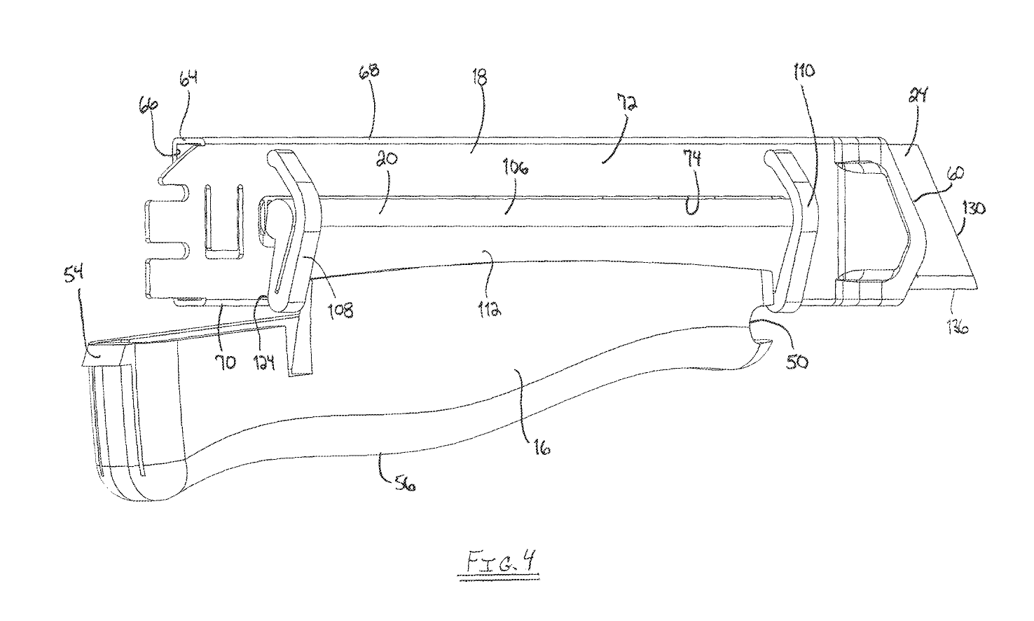

FIG. 1 illustrates a knife 12, which is a utility knife in the illustrated embodiment. The knife 12 includes a first handle 14, a second handle 16 pivotally coupled to the first handle 14, a frame 18, a locking bar 20 (FIG. 4), a blade carrier 22, and a blade 24.

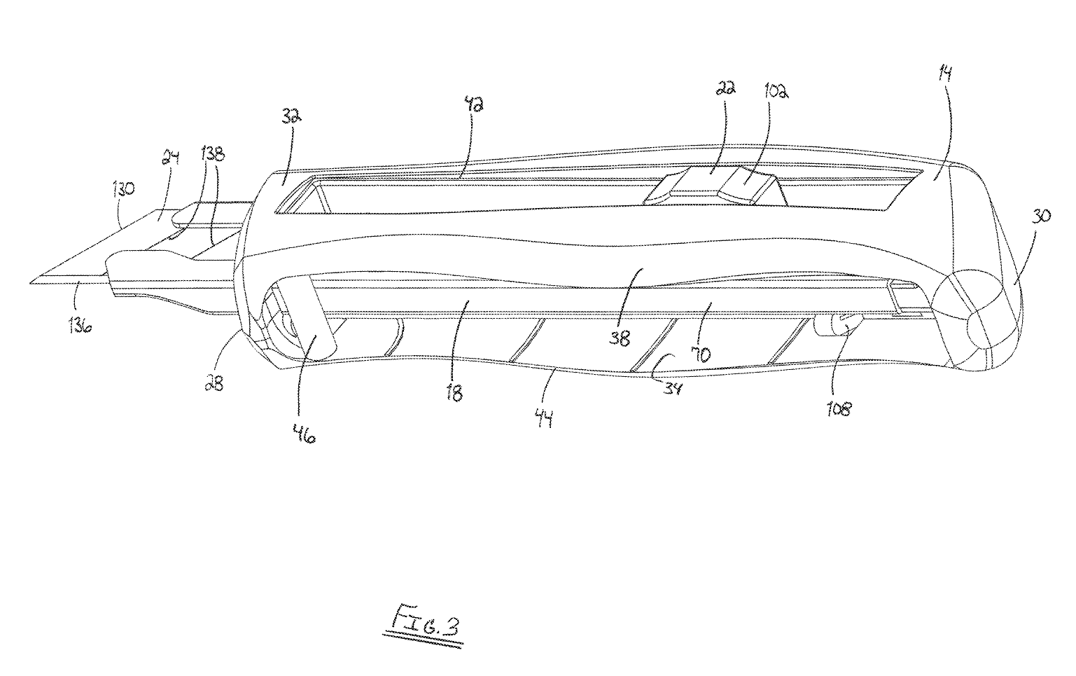

With continued reference to FIG. 1, the first handle 14 includes a front end 28, back end 30, sidewalls 32 and 34 that extend from the front end 28 to the back end 30, and a top wall 36 and a bottom wall 38 that both extend from the front end 28 to the back end 30. The first handle 14 is generally hollow and includes an opening 40 in the front end 28 through which the frame 18 and the blade 24 extend. An elongated aperture 42 extends through the sidewall 32 between the front end 28 and the back end 30. Also, an elongated aperture 44 extends through the bottom wall 38 between the front end 28 and the back end 30. The second handle 16 pivots through the aperture 44. Referring to FIG. 3, a post 46 extends between the sidewalls 32 and 34 adjacent the front end 28 of the first handle 14 and near the aperture 44 to pivotally couple the second handle 16 to the first handle 14.

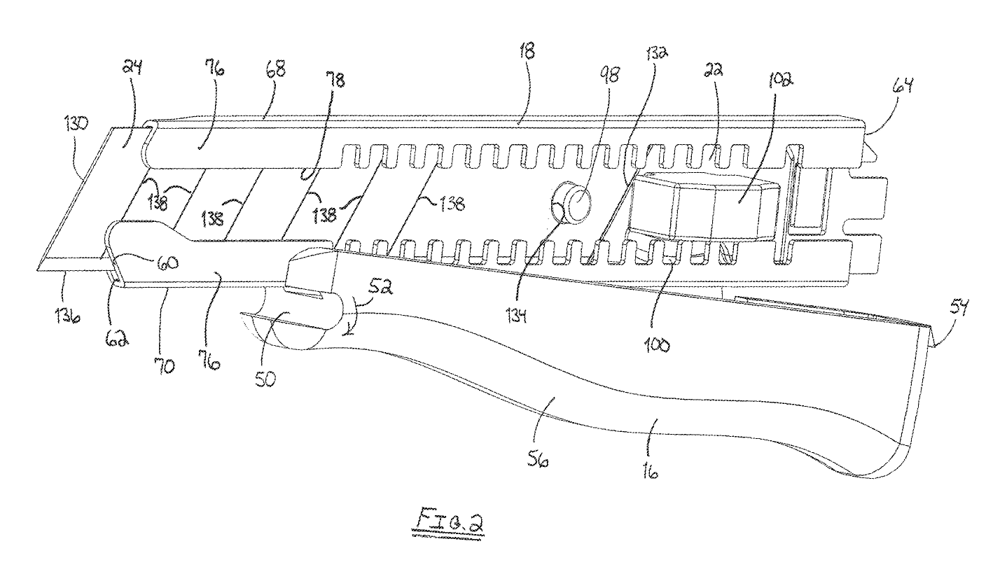

Referring to FIGS. 2 and 3, the second handle 16 includes a partially cylindrical recess 50 that receives the post 46 to pivotally couple the second handle 16 to the first handle 14 so that the second handle 14 can pivot about the post 46. Although not illustrated, the knife 12 can include a biasing member, such as a spring, to rotationally bias the second handle 16 with respect to the first handle 14 about the post 46 generally in the direction of arrow 52 of FIG. 2. The second handle 16 includes a hook 54 that limits rotational movement of the second handle 16 with respect to the first handle 14 about the post 46 in the direction of the arrow 52 and inhibits the second handle 16 from rotating past the position illustrated and FIG. 1 and uncoupling from the first handle 14. The second handle 16 is also generally hollow and can be configured to retain spare blades 24. The second handle 16 further includes a contoured grip surface 56 that is configured to provide an ergonomic grip for the user's fingers when the user grabs the knife 12 with the top wall 36 of the first handle 14 generally in the user's palm.

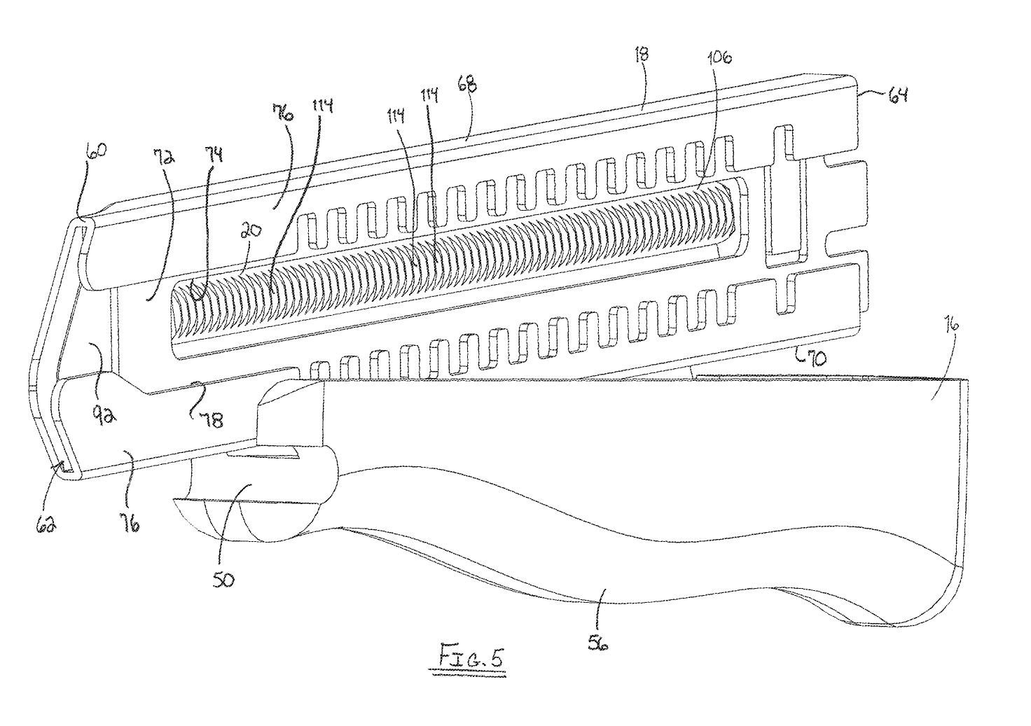

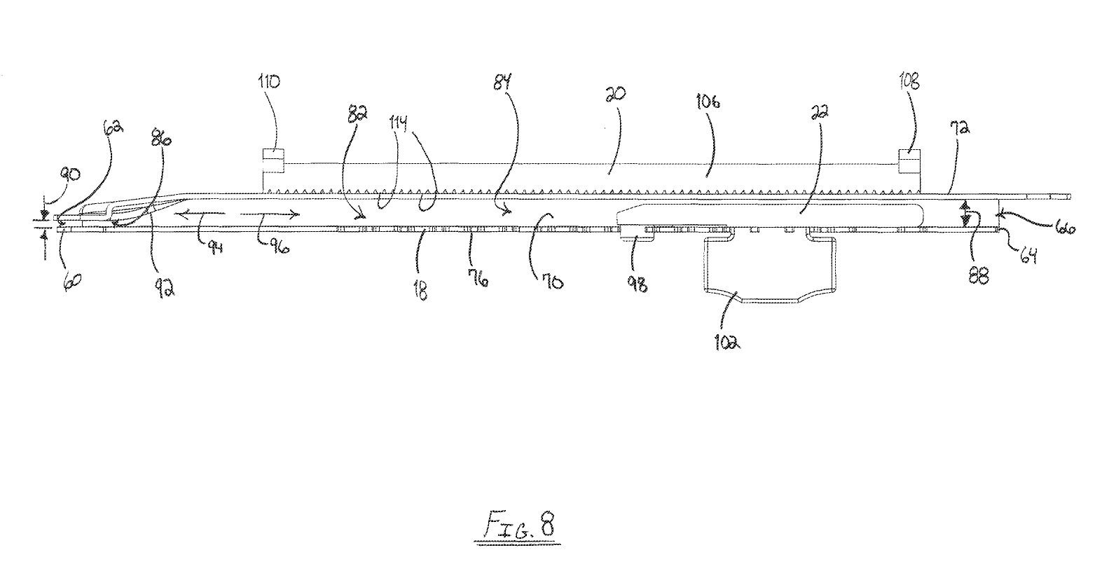

Referring to FIGS. 5 and 8, the frame 18 includes a front end 60 that includes an opening 62 and a back end 64 that includes an opening 66. The frame 18 further includes a top wall 68 and a bottom wall 70 that both extend from the opening 62 at the front end 60 to the opening 66 at the back end 64. A first sidewall 72 of the frame 18 extends from the top wall 68 to the bottom wall 70 and the first sidewall 72 includes an elongated aperture 74 between the openings 62 and 66. A second sidewall 76 extends from the top wall 68 to the bottom wall 70 opposite the first sidewall 72 and the second sidewall 76 includes an elongated aperture 78 that extends from the opening 62 to the opening 66. The aperture 78 extends through the opening 66 so that the blade carrier 24 can travel through the opening 66 to change the blade 24.

With continued reference to FIGS. 5 and 8, the frame 18 defines a track 82 that extends from the opening 62 at the front end 60 of the frame 18 and through the opening 66 at the back end 64 of the frame 18. The track 82 has a first portion 84 adjacent the back end 64 and a second portion 86 adjacent the front end 60 and the opening 62. The first portion 84 of the track 82 has a width 88 defined as the distance between sidewalls 72 and 76 and the second portion 86 of the track 82 has a width 90 that is less than the width 88. The reduced width 90 of the second portion 86 is created, at least in part, by an angled portion 92 of the first wall 72. The width 88 is sized to guide movement of the blade carrier 22 in the direction of arrows 94 and 96 in FIG. 8 and the width 90 is sized to guide movement of the blade 24 in the direction of the arrows 94 and 96. The angled portion 92 of the wall 72 is positioned to act as a stop to limit movement of the blade carrier 22 past the stop 92 in the direction of arrow 94 and prevent the blade carrier 22 from traveling through the opening 62 at the front end 60 of the frame 18.

Referring to FIGS. 8-10, the blade carrier 22 is received in the first portion 84 of the track 82 and the blade carrier 22 slides with respect to the frame 18 along the first portion 84 of the track 82 in the direction of the arrows 94 and 96 of FIG. 8. The blade carrier 22 includes a projection 98, a friction member 100, and an actuator 102. The projection 98 extends through the blade 24 to couple the blade 24 with the carrier 22 for movement with the carrier 22 with respect to the frame 18. The friction member 100 contacts the bottom wall 70 of the frame 18 to provide enough friction between the carrier 22 and the frame 18 to inhibit sliding movement of the carrier 22 along the track 82 caused by the force of gravity. Therefore, in the illustrated embodiment, a user must apply at least some force to the carrier 22, via the actuator 102 in one method, to slide the carrier 22 along the track 82 and the force of gravity is insufficient to cause the carrier 22 to move in the direction of arrows 94 and 96 along the track 82.

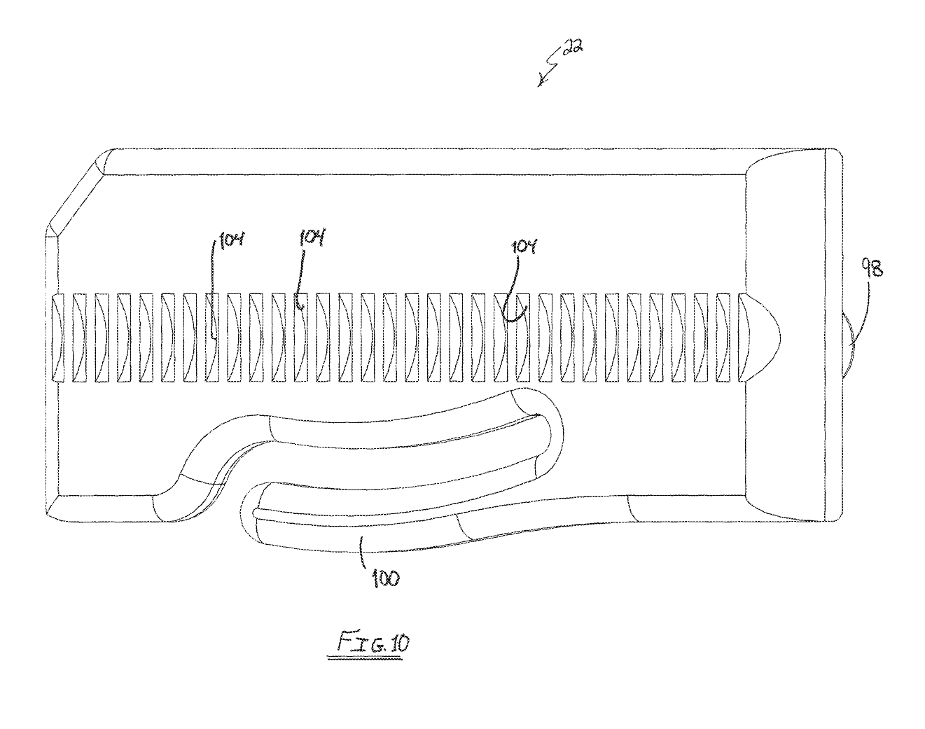

Referring to FIGS. 1 and 2, the actuator 102 extends through the aperture 42 of the first handle 14 and the aperture 78 of the frame 18 to provide the user with a place to grip the carrier 22, such as with the user's thumb in one method, to slide the carrier 22 with respect to the frame 18 and the handle 14. Referring to FIG. 10, the carrier 22 further includes a plurality of recesses 104 located on a side of the carrier 22 opposite the actuator 102. As will be discussed in more detail below, the recesses 104 are engaged by the locking bar 20 via movement of the second handle 16 to inhibit movement of the carrier 22 and the blade 24 with respect to the handle 14 and the frame 18.

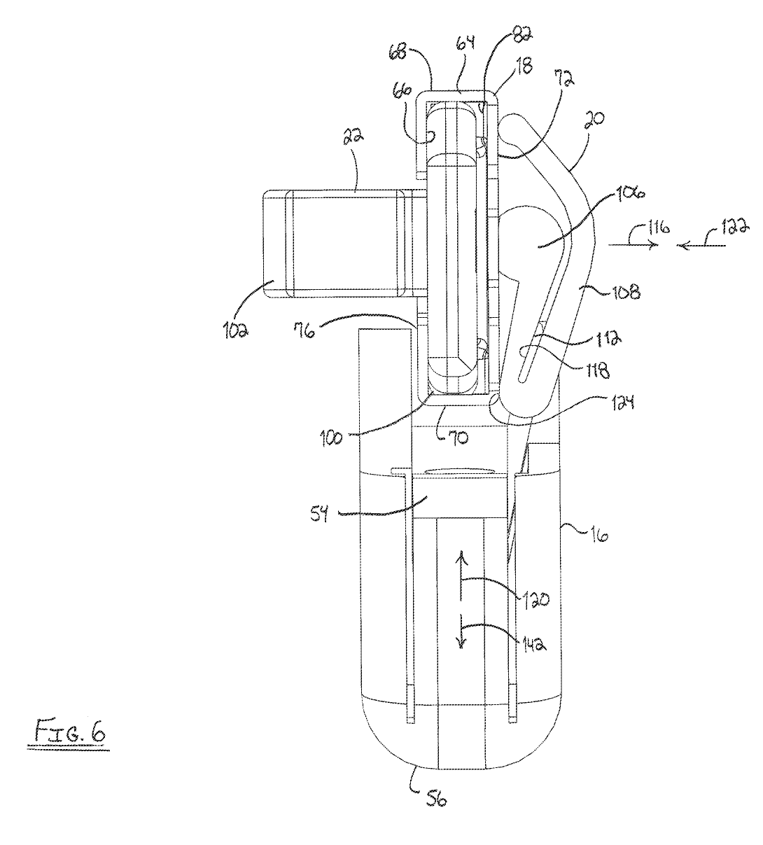

Referring to FIGS. 4-6, the illustrated locking bar 20 includes a locking portion 106, a first biasing member 108, a second biasing member 110, and an actuating surface 112. The locking portion 106 includes projections 114 that face the blade carrier 22 and the projections 114 are sized to be received in the recesses 104 (FIG. 10) of the carrier 22. The locking portion 106 and the projections 114 are sized to extend through the aperture 74 of the frame 18 and the locking portion 106, and the projections 114 extend along a great majority of the first portion 84 (FIG. 8) of the track 82. The biasing members 108, 110 are located at opposite ends of the locking portion 106 in the illustrated embodiment. The illustrated biasing members 108, 110 are leaf springs that bias the locking portion 106 generally in the direction of arrow 116 of FIG. 6 and away from and out of engagement with the blade carrier 22. As best seen in FIG. 6, the actuating surface 112 is angled or inclined away from the blade carrier 22. The second handle 16 includes an actuating surface 118 that has an angle or inclination that matches the actuating surface 112 such that movement of the second handle 16 in the direction of arrow 120 causes the surface 118 to slide along the surface 112 to pivot the locking portion 106 in the direction of arrow 122 about pivot points 124, which will be discussed in more detail below.

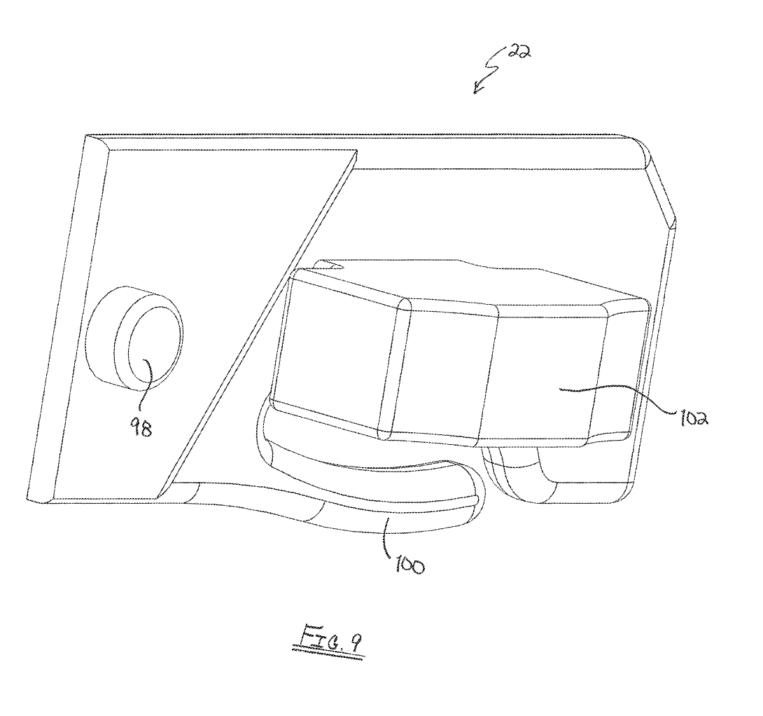

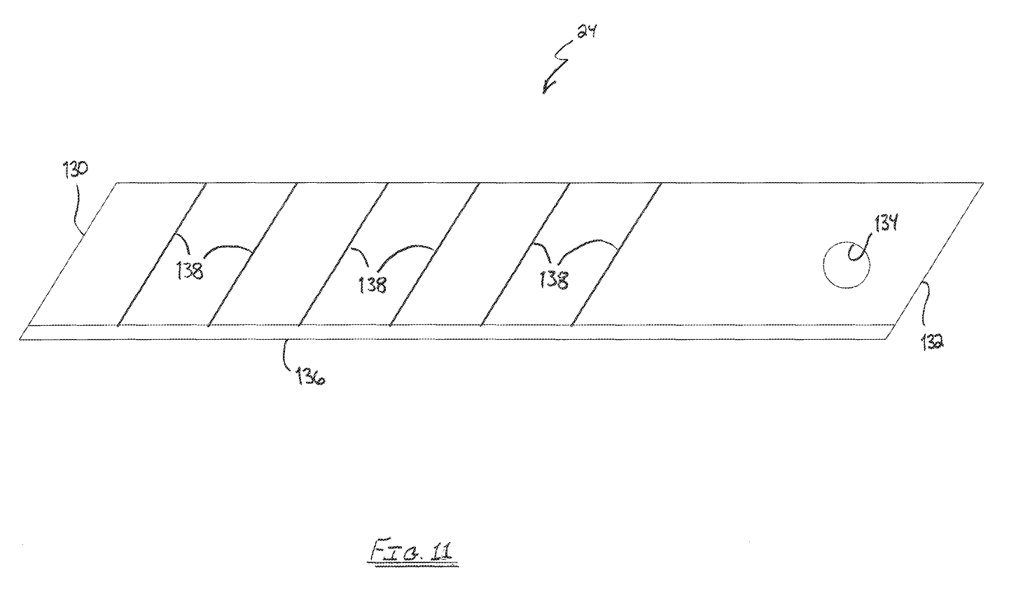

Referring to FIG. 11, the blade 24 includes a front end 130, a back end 132, and an aperture 134 adjacent the back end 132 that receives the projection 98 (FIG. 9) of the carrier 22 to couple the blade 24 to the carrier 22. A cutting edge 136 extends along the blade 24 from the front end 130 to the back end 132. Parallel score marks 138, which are parallel to the front end 130 and at an acute angle with respect to the cutting edge 136, are located between the ends 130 and 132. The score marks 138 allow the user to break the blade 24 along a score mark 138 if a portion of the cutting edge 136 between the score mark and the front end 130 becomes worn or dull.

In operation, referring to FIGS. 1, 6, and 8, a user moves the blade carrier 22 in the direction of the arrow 94 by sliding the blade carrier 22 in the track 82 to extend a desired amount of the cutting edge 136 out of the opening 62 to cut a work-piece. When the desired amount of the cutting edge 136 has been exposed, for example, as illustrated in FIG. 1, the user pivots the second handle 16 with respect to the first handle 14 about the post 46 (FIG. 3). The user pivots the second handle 16 by squeezing the second handle 16 and the first handle 14, which causes the second handle 16 to move in the direction of the arrow 120 in FIG. 6. As the second handle 16 moves in the direction of arrow 120, the actuating surface 118 of the second handle 16 slides along the actuating surface 112 of the locking bar 20, which causes the locking portion 106 to move in the direction of the arrow 122 of FIG. 6. Continued movement of the locking portion 106 in the direction of the arrow 122 causes the projections 114 (FIG. 8) to engage the recesses 104 (FIG. 10) of the carrier 22. Engagement between the recesses 104 and the projections 114, as the user continues to squeeze the handles 14 and 16, locks the blade 24 and the blade carrier 22 from movement along the track 82 and with respect to the handles 14 and 16 so that the user can use the cutting edge 136 to cut a work-piece.

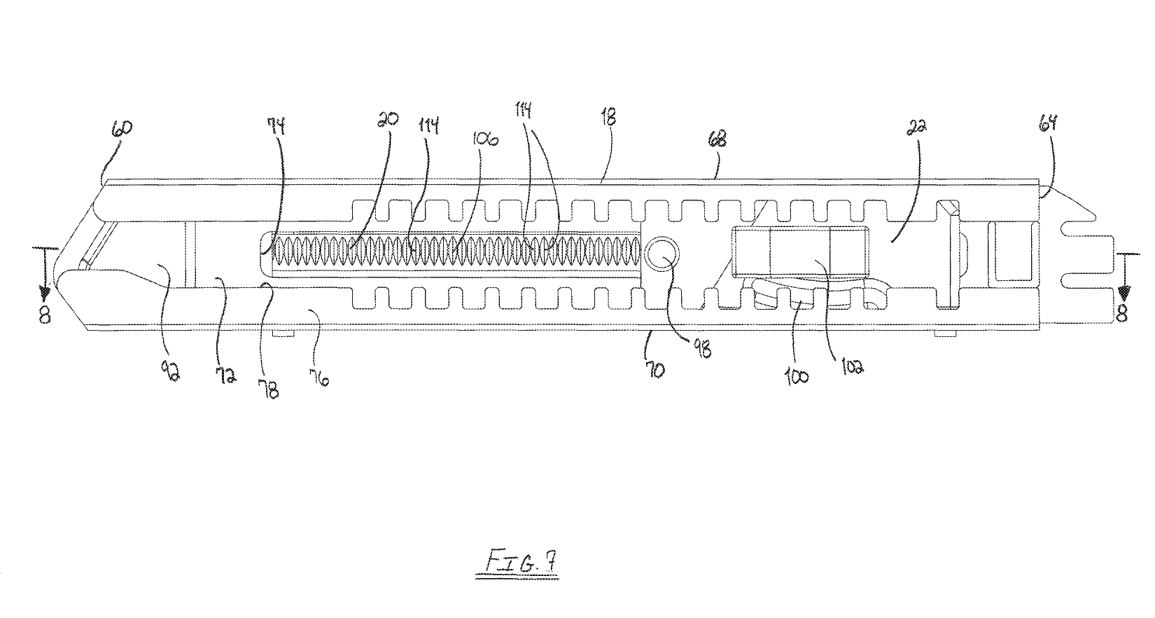

After the work-piece has been cut, the user can release the force applied to the handles 14 and 16 that was caused by squeezing the handles 14 and 16. This release causes the second handle 16 to pivot about the post 46 (FIG. 3) with respect to the first handle 14 generally in the direction of the arrow 52 of FIG. 2. Referring to FIG. 6, such pivoting movement causes the second handle 16 to move in the direction of arrow 142, which causes the actuating surface 118 of the handle 16 to slide down the actuating surface 112 of the locking bar 20 to allow the biasing members 108 and 110 to move the locking portion 106 and the projections 114 out of engagement with the recesses 104 (FIG. 10) of the carrier 22. Then, the user can retract the blade 24 via the actuator 102 of the carrier 22 to move the entire cutting edge 136 into the frame 18 so that the cutting edge 136 does not extend past the opening 62. With the blade 24 in the desired position, the friction member 100 (FIG. 7) of the carrier 22 provides enough friction against the bottom wall 70 of the frame 18 to prevent movement of the carrier 22 along the track 82 from the force of gravity.

Referring to FIGS. 1 and 8, although not illustrated, in one embodiment the back end 30 of the first handle 14 includes an aperture for removal and replacement of the blade 24. In such an embodiment, the user slides the carrier 22 through the back opening 66 of the frame 18 and through the aperture in the back end 30 of the handle 14 to remove the carrier 22 and the blade 24 from the frame 18 and the handle 14. The user can then attach a new blade 24 to the carrier 22 and insert the blade 24 and the carrier 22 back through the aperture at the back end 30 of the handle 14 and through the opening 66 in the back end 64 of the frame 18.

Thus, the invention provides, among other things, a knife where the blade can easily be extended from the handle and refracted into the handle and can be securely held in a cutting position by squeezing the handle.

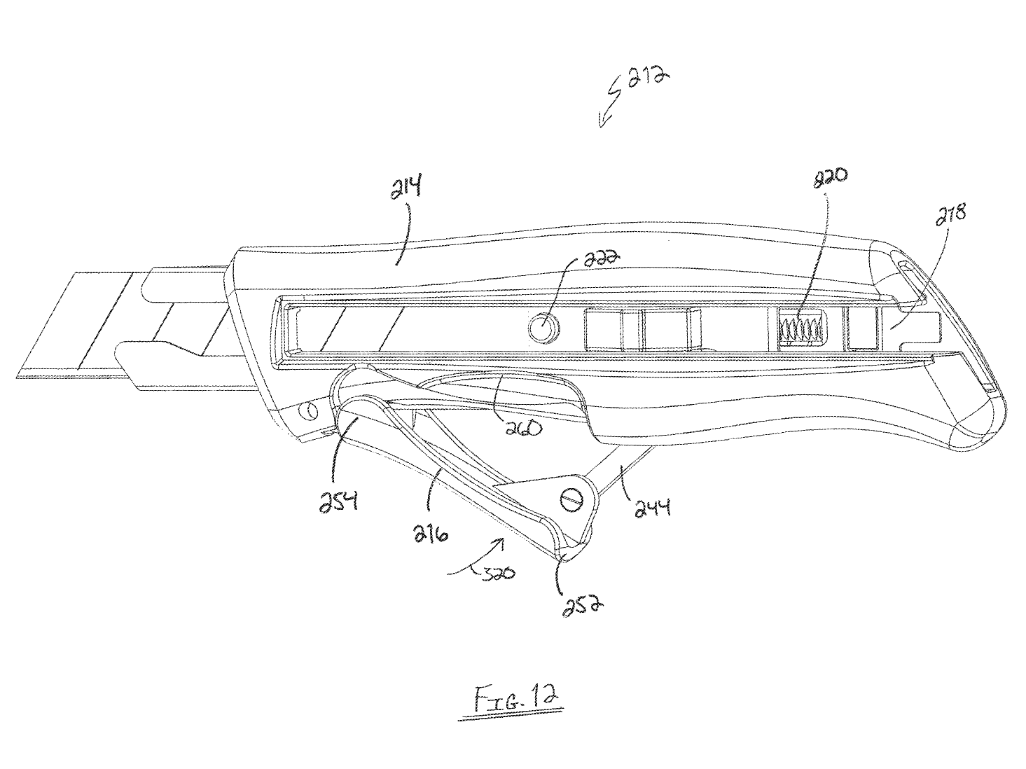

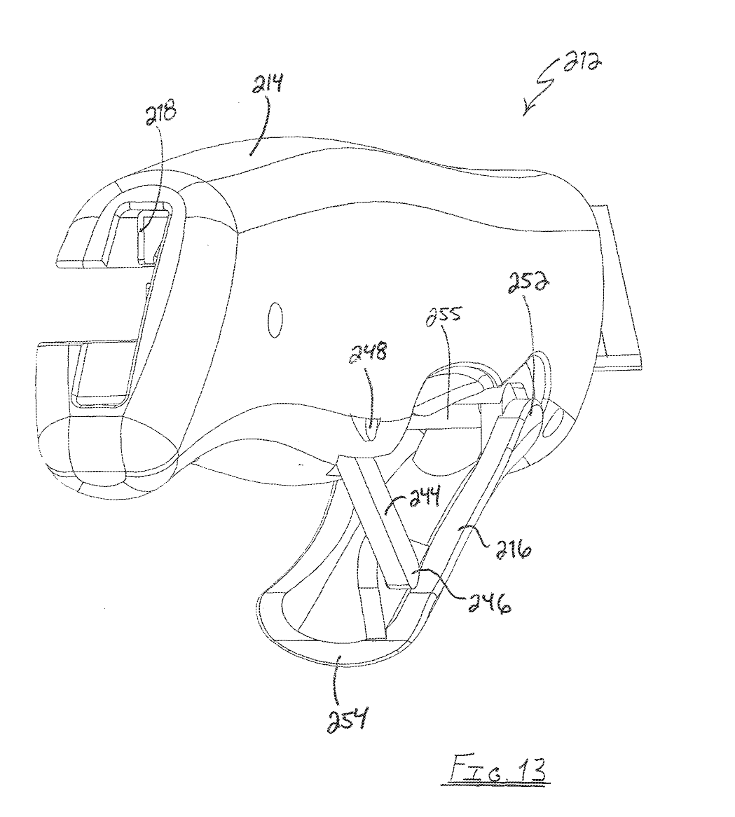

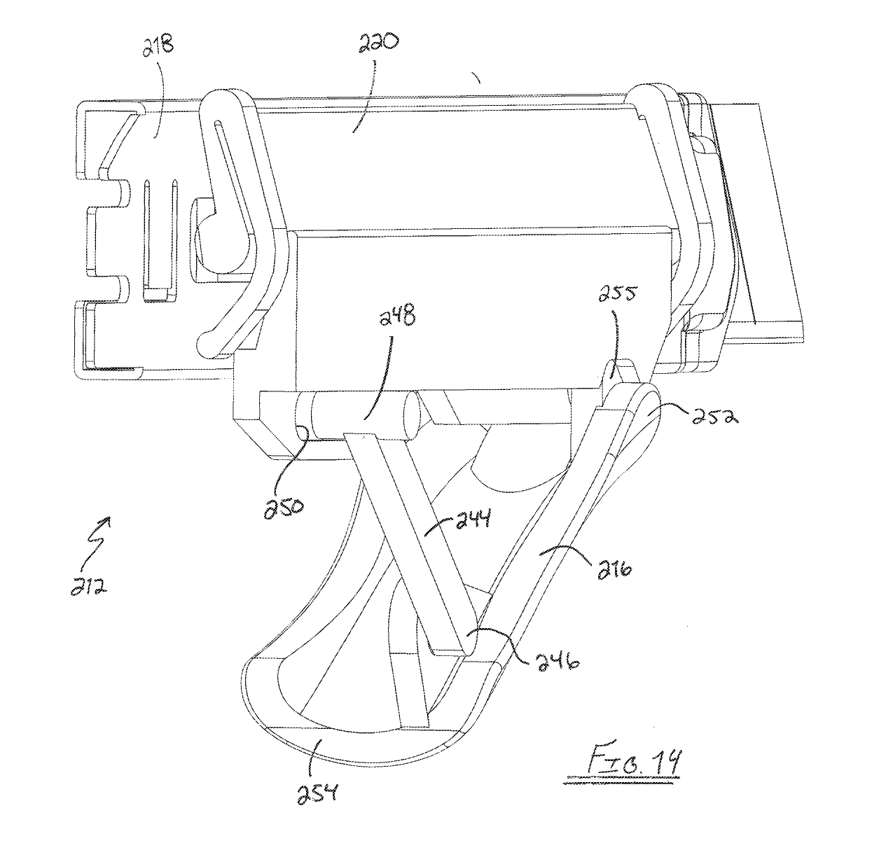

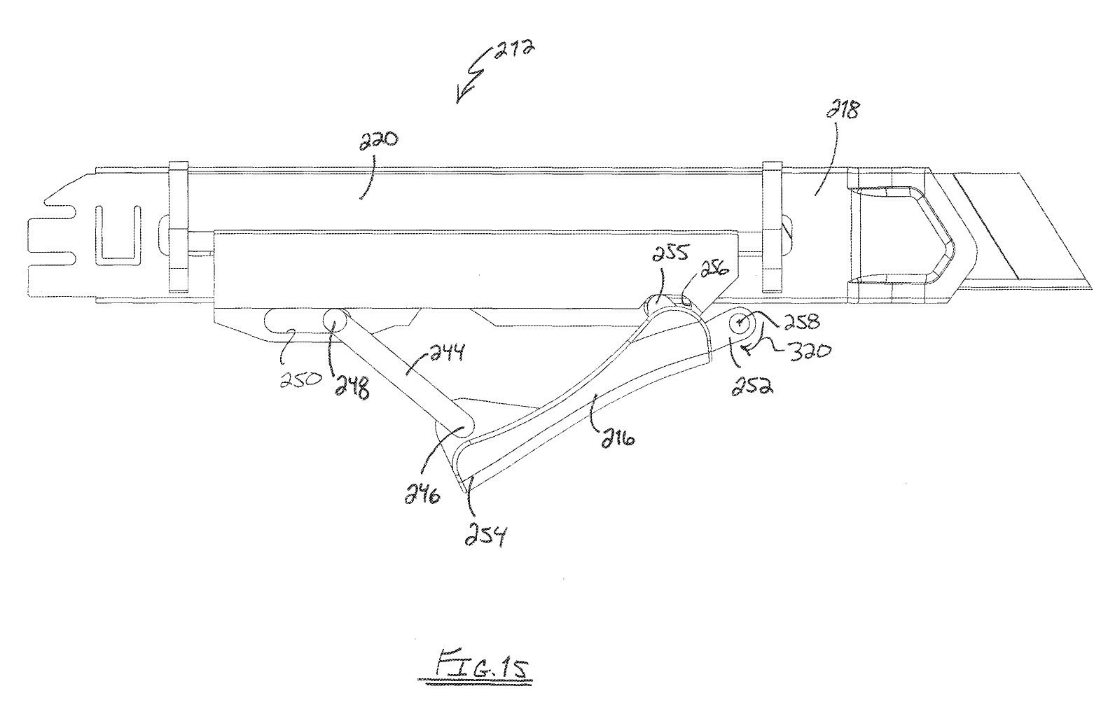

FIGS. 12-15 illustrate a utility knife 212 according to another embodiment of the invention. The knife 212 is similar to the knife 12 discussed above and only differences between the knives 12 and 212 will be discussed in detail below and like component have been given like reference numbers plus 200. The knife 212 includes a link 244 that interconnects the second handle 216 and the locking bar 220. The link 244 includes a first end 246 and a second end 248. The first end 246 is pivotally coupled to the handle 216. The second end 248 is pivotally and slidably coupled to the locking bar 220 via an elongated aperture 250 of the locking bar 220. The handle 216 includes a front end 252 and a back end 254. The link 244 is pivotally coupled to the handle 216 adjacent the back end 254 of the handle 216 and the second handle 216 is pivotally coupled to the first handle 214 (FIG. 12) adjacent the front end 252 of the second handle 216. Between the front end 252 and the back end 254, a pin 255 pivotally and slidably couples the second handle 216 directly to the locking bar 220 via an elongated aperture 256 in the locking bar 220.

In operation, to lock the blade carrier 222 in the desired position relative to the frame 218, the user pivots the second handle 216 relative to the first handle 214 in the direction of arrow 320 about a pivot 258 until the second handle 216 moves from the position illustrated in FIGS. 12-15 and is received in a recess 260 of the first handle 214. When the second handle 216 is pivoted into the recess 260, the link 244 locks the handle 216 in this closed position (open positions illustrated in FIGS. 12-15). With the handle 216 in the closed position, the locking bar 220 moves to lock and hold the blade carrier 222 in the desired position as discussed above with regard to the knife 12 of FIGS. 1-11. Accordingly, the user does not need to squeeze the second handle 216 each time the user uses the knife, but rather only when the user desires to change the location of the blade carrier 222 relative to the frame 218.

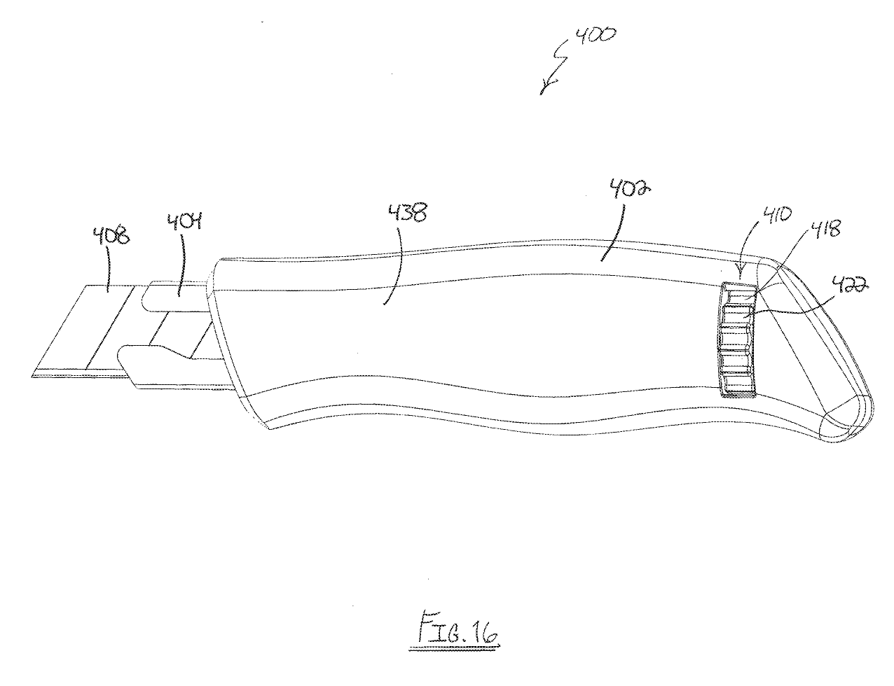

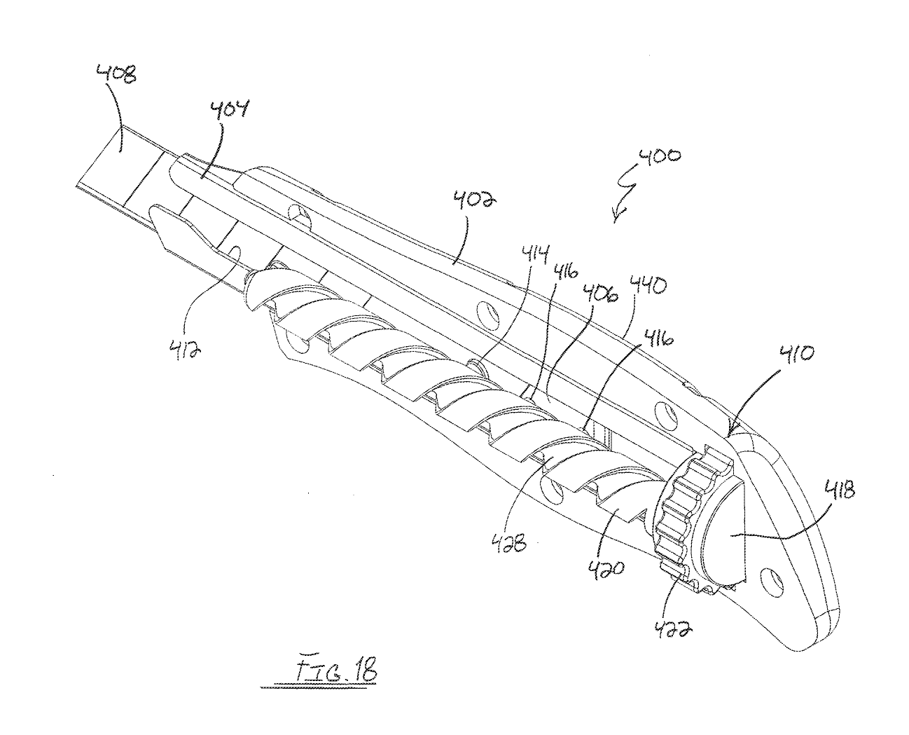

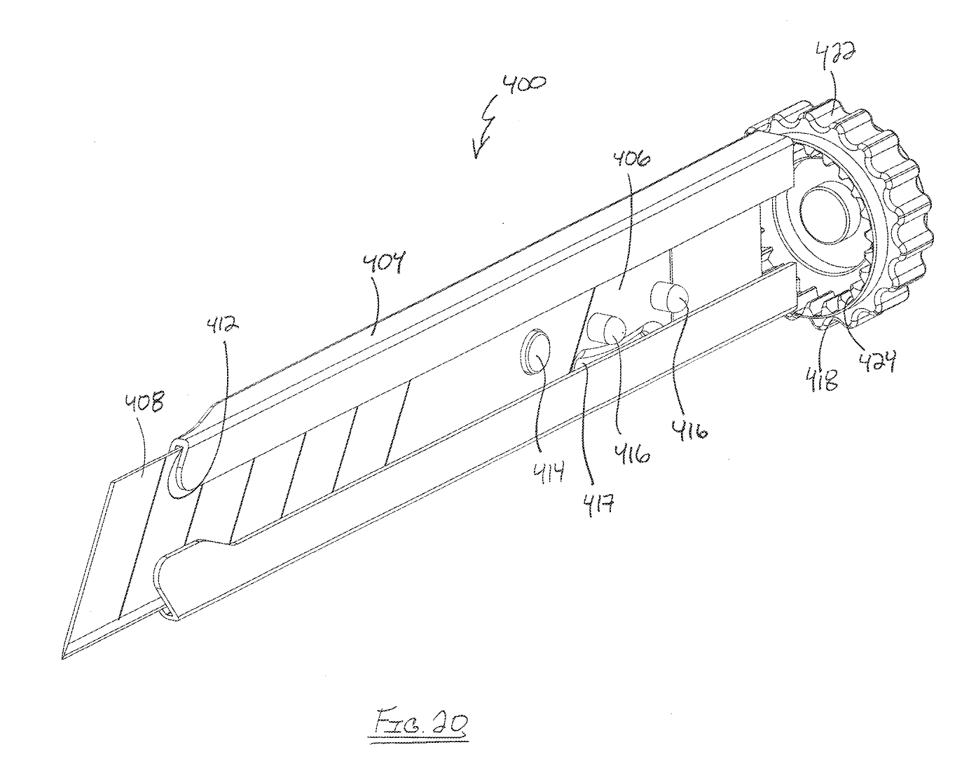

FIGS. 16-21 illustrate a knife 400 according to another embodiment of the invention. The knife 400 includes a handle 402, a frame 404, and a blade carrier 406 that positions a blade 408 relative to the handle 402 and the frame 404. The knife 400 further includes an actuator and drive assembly 410 that positions the blade carrier 406, and therefore the blade 408, in the desired position.

The frame 404 includes a track 412, and the carrier 406 slides within the track 412 to position the blade 408 in the desired position. The carrier 406 includes a first projection 414 that extends through the blade 408 to couple the blade 408 to the carrier 406 for movement relative to the track 412. The carrier 406 further includes projections 416 that interact with the actuator and drive assembly 410 to move the carrier 406, as will be discussed in more detail below. The carrier 406 further includes a friction member 417 that creates friction between the carrier 406 and the track 412 to inhibit undesired movement of the carrier 406 relative to the track 412 when the carrier 406 is not being moved by the actuator and drive assembly 410.

The actuator and drive assembly 410 includes an actuator 418 and a drive shaft 420. The actuator 418 includes a dial portion 422 that allows the user to rotate the actuator 418 using their thumb and index or forefinger. The actuator 418 further includes an internal ring gear 424. The drive shaft 420 includes a spur gear 426 that meshes with the ring gear 424 such that rotation of the actuator 418 rotates the drive shaft 420. The drive shaft 420 further includes a helical recess 428 that extends along the length of the shaft 420 and rotation of the shaft 420 rotates the recess 428. The projections 416 of the blade carrier 406 are received in the helical recess 428 such that rotation of the recess 428 causes linear movement of the blade carrier 406 along the track 412.

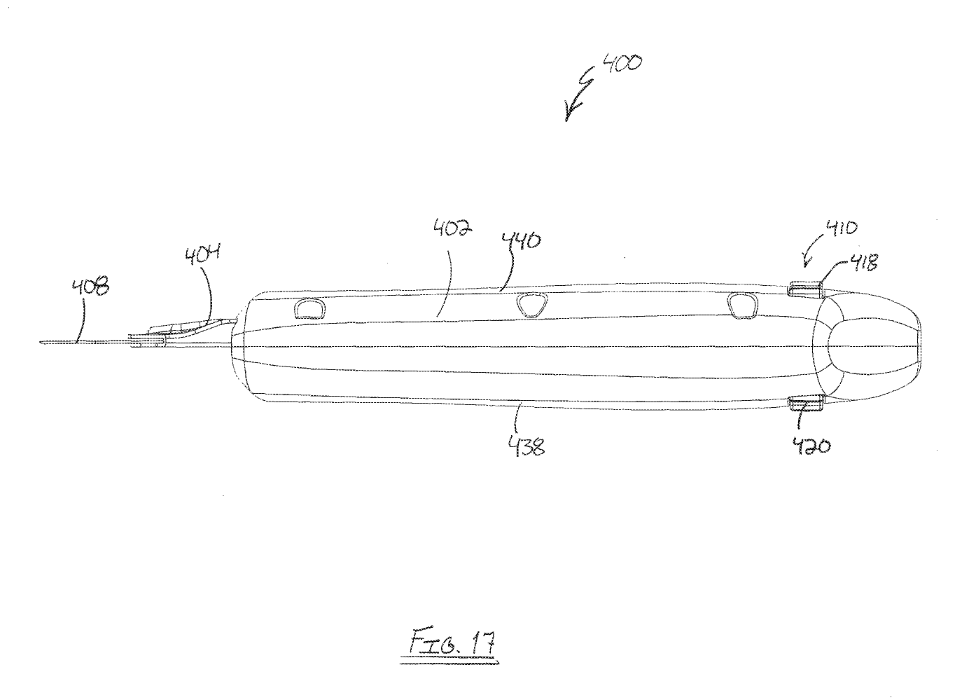

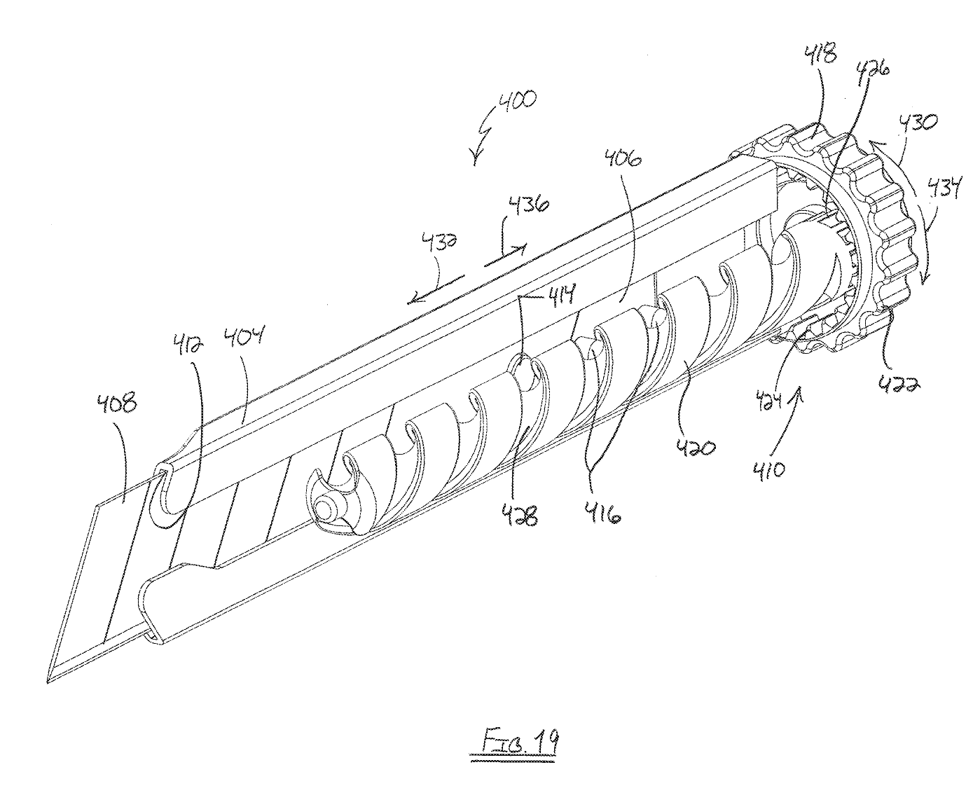

In operation, the user rotates the dial portion 422 of the actuator 418 in the direction arrow 430 (FIG. 19), which causes the blade carrier 406 to move along the track 412 in the direction of arrow 432 to extend the blade 408 from the handle 402 so that the blade 408 can be used to cut a work-piece. When the user is finished using the blade 408, the user rotates the actuator 418 in the direction of arrow 434, which causes the carrier 406 and the blade 408 to move in the direction of arrow 436 and into the handle 402. In the illustrated embodiment the gears 424 and 426 and the helical recess 428 are sized such that ¼ revolution of the dial portion 422 results in the carrier 406 translating ½ inch along the track 412. The illustrated arrangement of the actuator and drive assembly 410 allows the blade 408 to be centrally positioned between sides 438, 440 (FIG. 17) of the handle 402.

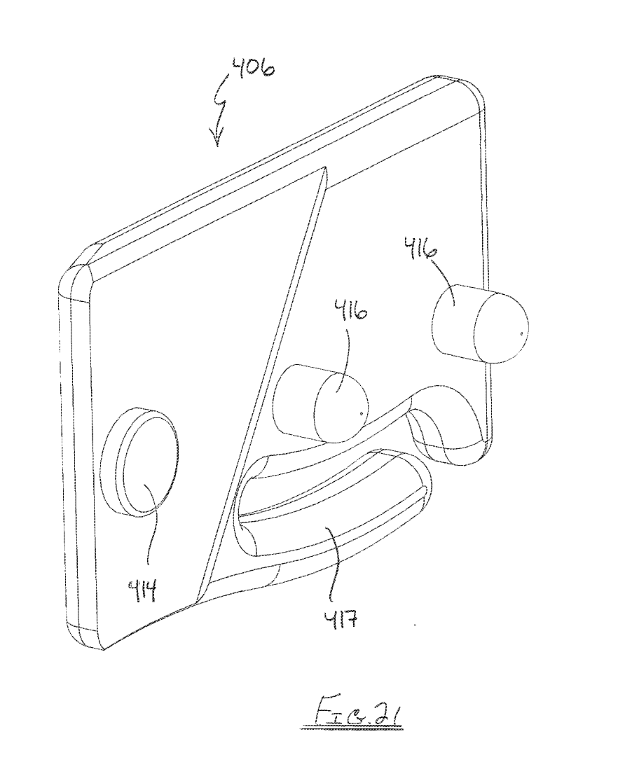

FIGS. 22-29 illustrate a knife 500 according to another embodiment of the invention. The knife 500 includes a handle 502, a frame 504, and a blade carrier 506 that positions a blade 508 relative to the handle 502 and the frame 504. The knife 500 further includes an actuator 510 that positions the blade carrier 506, and therefore the blade 508, in the desired position.

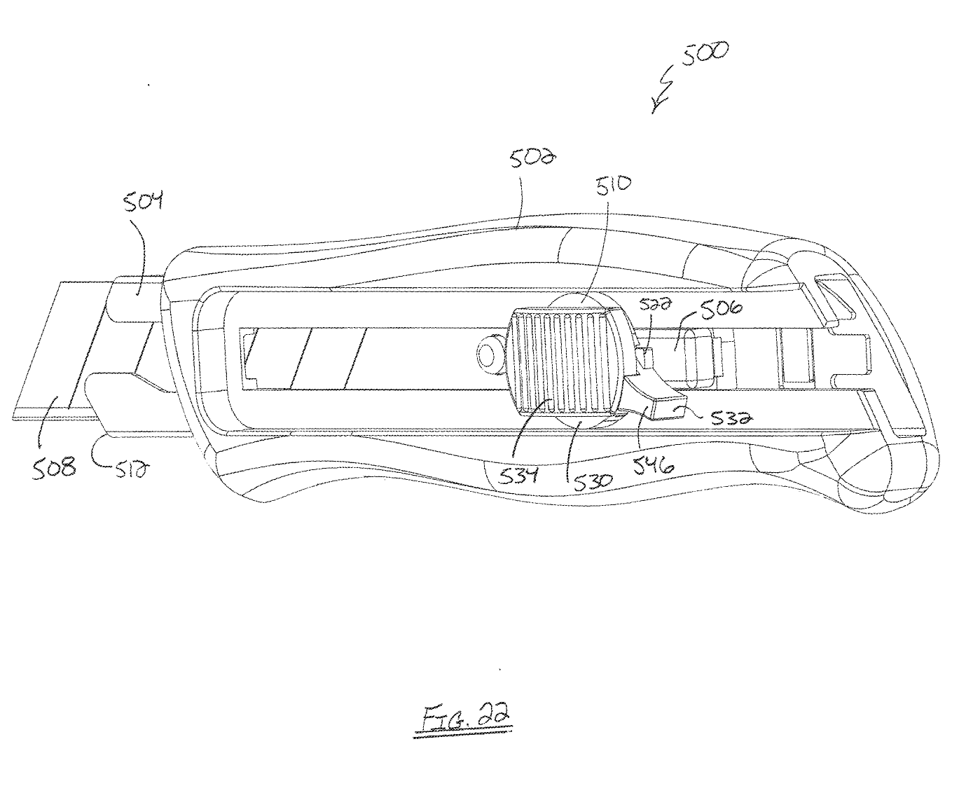

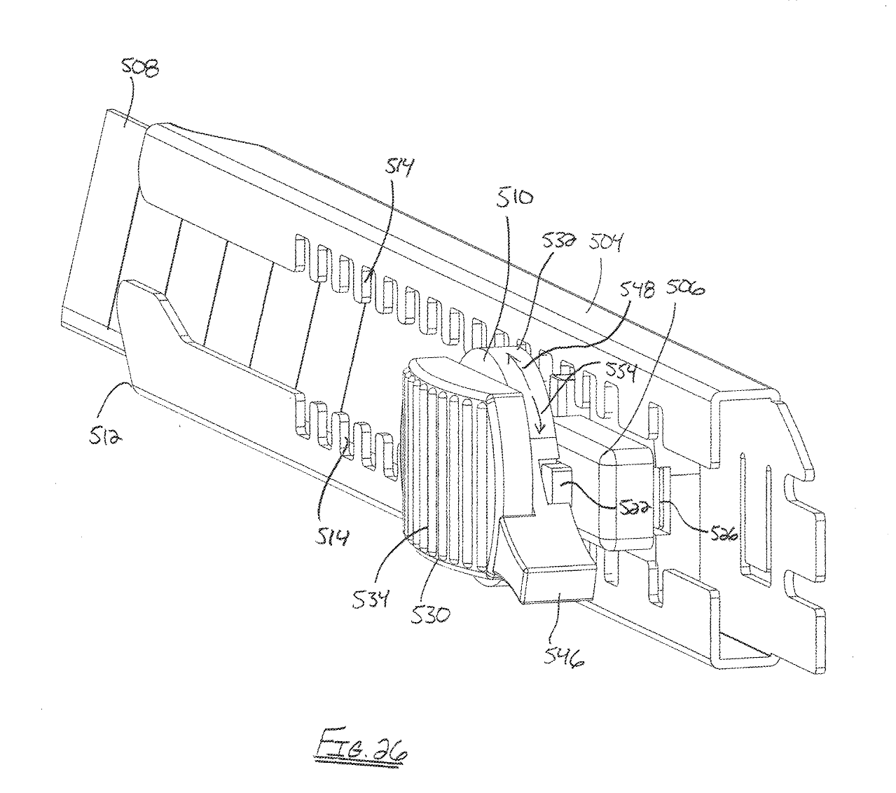

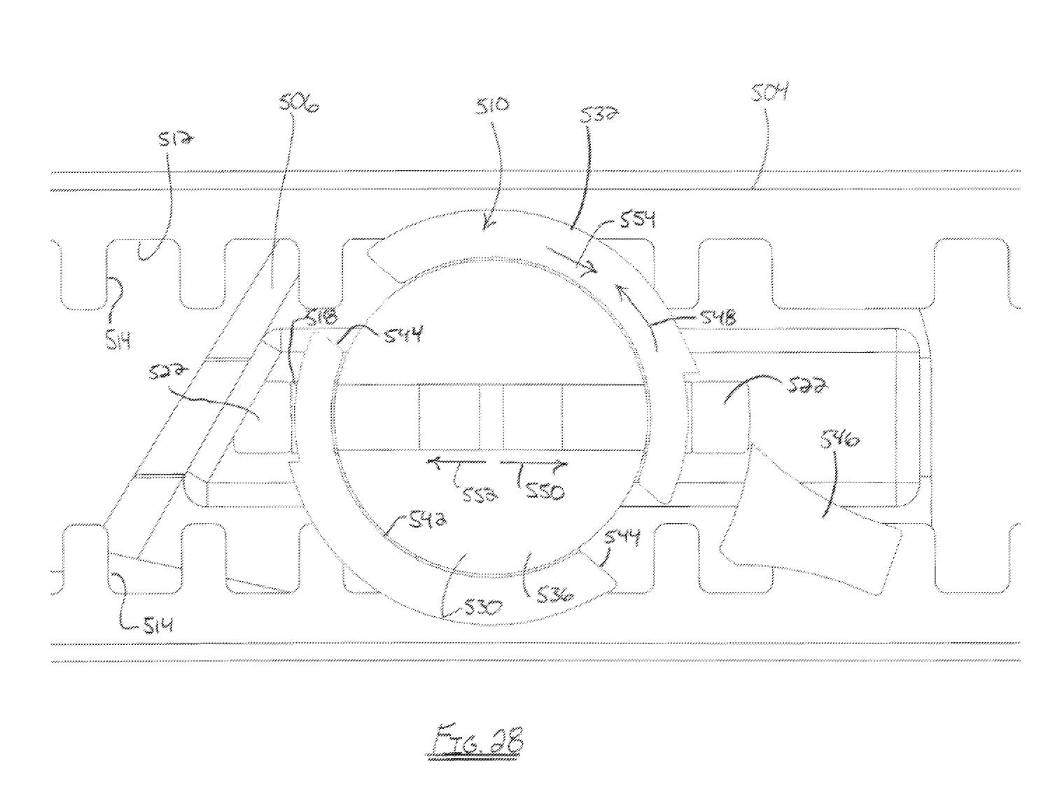

Referring to FIG. 23, the frame 504 includes a track 512 and recesses 514 evenly spaced along the track 512. The carrier 506 slides within the track 512 to position the blade 508 in the desired position. The carrier 506 (FIG. 29) includes a projection 516 that extends through the blade 508 to couple the blade 508 to the carrier 506. The carrier 506 further includes an elongated aperture 518 having a length 520. Projections 522 are located at each end of the aperture 518. As best seen in FIGS. 27 and 29, a locking member 524 is coupled to the carrier 506 for movement with the carrier 506 along the track 512. The locking member 524 includes a biasing member 526, which is a leaf spring in the illustrated embodiment, and a projection 528 coupled to the spring 526.

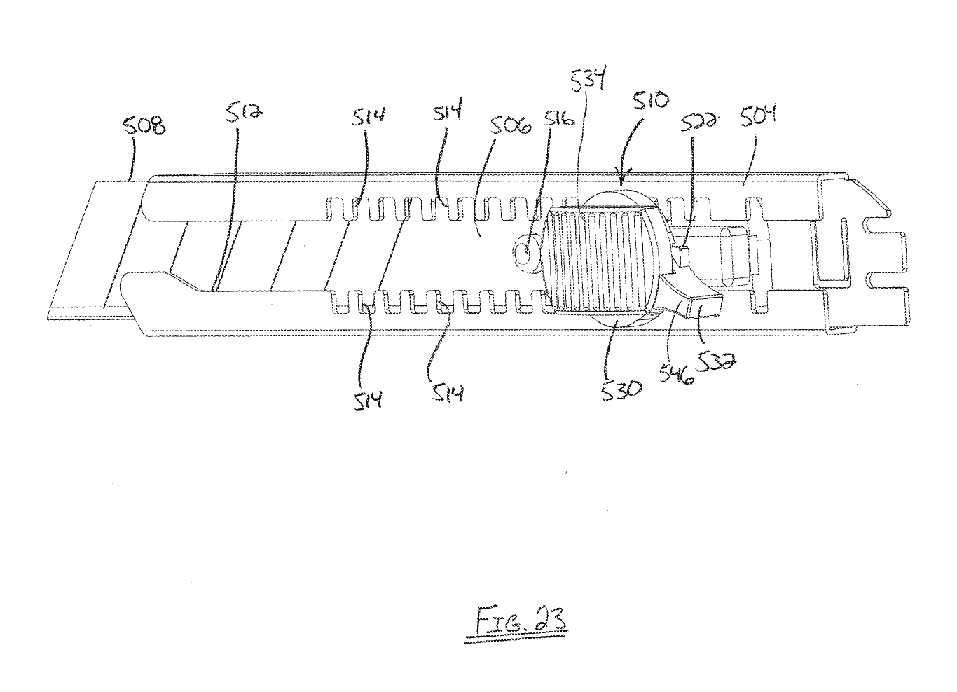

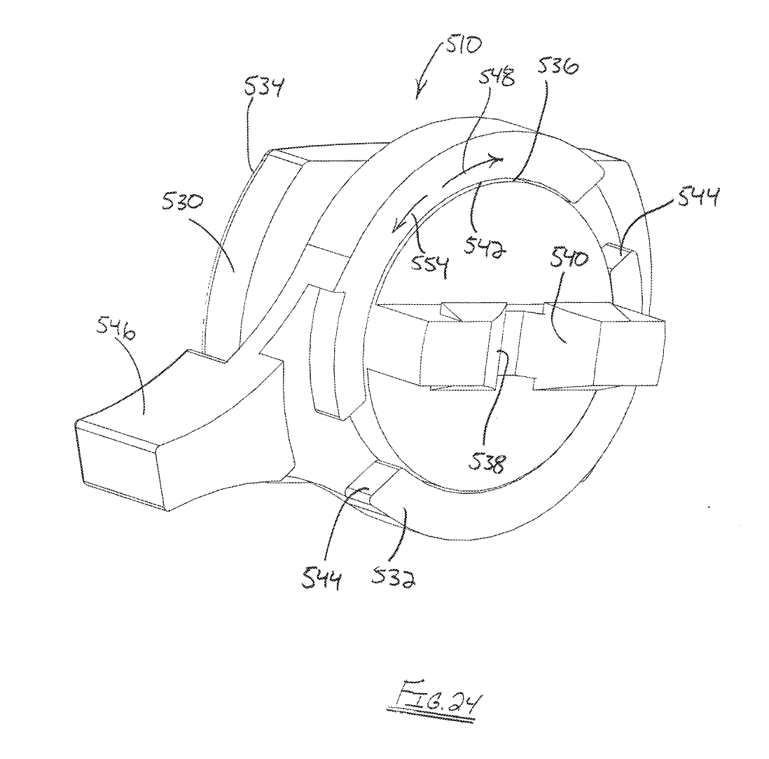

Referring to FIGS. 24 and 25, the actuator 510 includes a button 530 and a lock 532 that is rotatably coupled the button 530. The button 530 includes a friction surface 534 that is engaged by a user's finger to both push and slide the button 530 relative to the frame 504. The button 530 includes a post 536 that rotatably couples the lock 532 to the button 530. The button 530 further includes a forward facing cam surface 538 and a rearward facing cam surface 540 that are used to move the projection 528 of the locking member 524 out of the recesses 514 of frame 504, as will be discussed in more detail below. The lock 532 includes an aperture 542 that receives the post 536 of the button 530 to rotatably couple the lock 532 and the button 530. The lock 532 further includes apertures 544 that are space approximately 180 degrees from each other around the aperture 542. The lock 532 further includes a lever 546 that allows the user to rotate the lock 532 relative to the button 530.

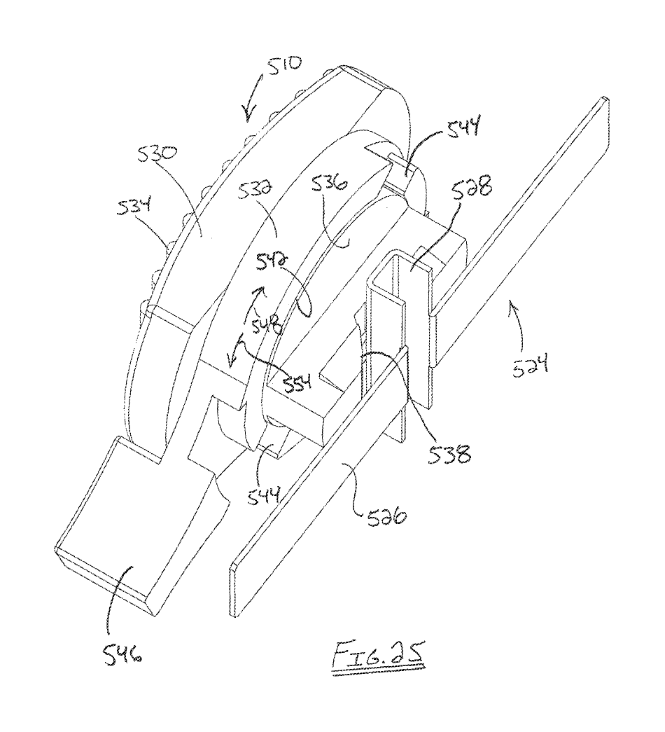

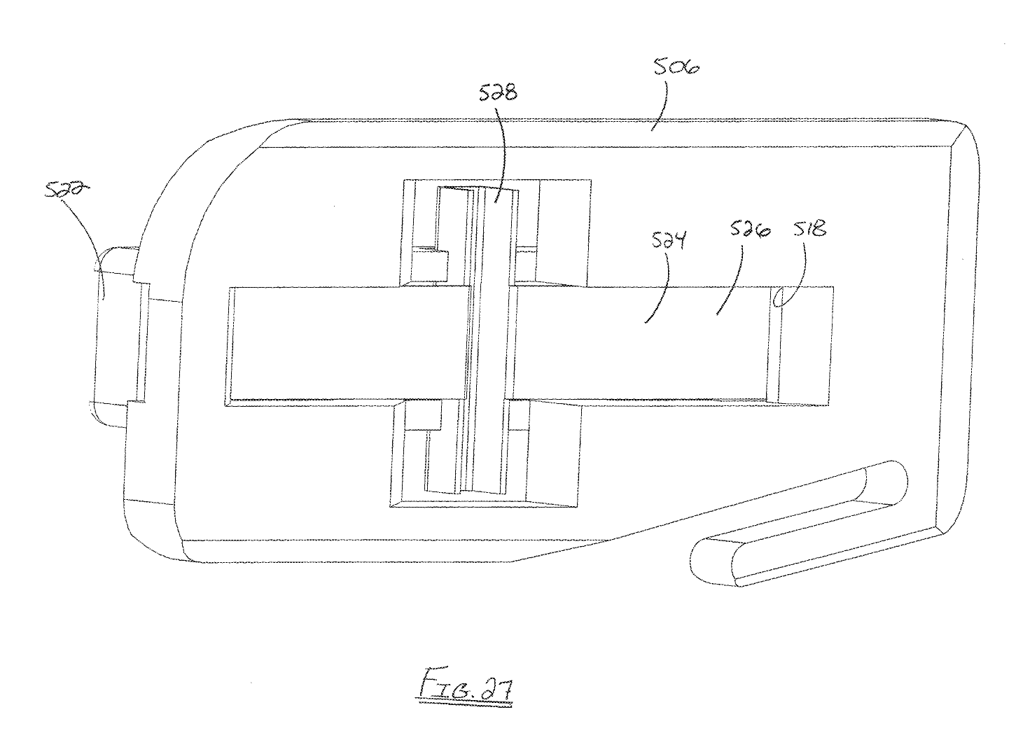

In operation, referring to FIGS. 26, 28, and 29, the carrier 506, and therefore the blade 508, is held in position relative to the frame 504 by the locking member 524. The projection 528 of the locking member 524 is received and held in two opposed recesses 514 of the frame 504 by the bias of the spring 526 of the locking member 524 to hold the carrier 506 in the desired position. With the carrier 506 in the desired position, as discussed above, the blade 508 is either extended for use or retracted for storage. In the illustrated embodiment, to move the carrier 506, and therefore the blade 508, relative to the track 512, the user pivots the lever 546 of the lock 532 relative to the button 530 from a locked position (FIGS. 26, 28, and 29) in the direction of arrow 548 to an unlocked position. The lever 546 is rotated until it reaches the unlocked position and stops rotating. In the unlocked position, the apertures 544 are aligned with the projections 522 of the carrier 506. In this position, the button 530 is allowed limited movement in the direction of arrows 550 and 552 relative to the carrier 506 because the projections 522 are allowed to move into the apertures 544. Movement of the button 530 in the direction of arrows 550 and 552 is limited by the projections 522. With the lever 546 in the unlocked position, to extend the blade 508 from the frame 504, the user slides the button 530 in the direction arrow 552. This causes the forward facing cam surface 538 (FIG. 24) to push the projection 528 of the locking member 524 against the bias of spring 526 and out of the recesses 514 in which the projection 528 was held. Then, the user can continue to slide the carrier 506 in the direction of arrow 552 to extend the blade 508 from the frame 504 and the handle 502. When the blade 508 is in the desired position, the user releases the button 530 which causes the projection 528 to automatically travel into adjacent opposed recesses 514 to hold the carrier 506 in the desired position. The user can move lever 546 back to the locked position (FIG. 28) by rotating the lever 546 in the direction of arrow 554 (FIG. 28) to inhibit unintentional movement of the carrier 506.

To retract the blade 508, the user rotates the lever 546 in the direction of arrow 548 to the unlocked position and moves the button 530 in the direction of arrow 550 (FIG. 28). Movement of the button 530 in the direction of arrow 550 causes the rearward facing cam surface 540 (FIG. 24) to move the projection 528 of the locking member 524 out of the recesses 514 in which the projection 528 was held, which allows the user to retract the blade 508 into the handle 502.

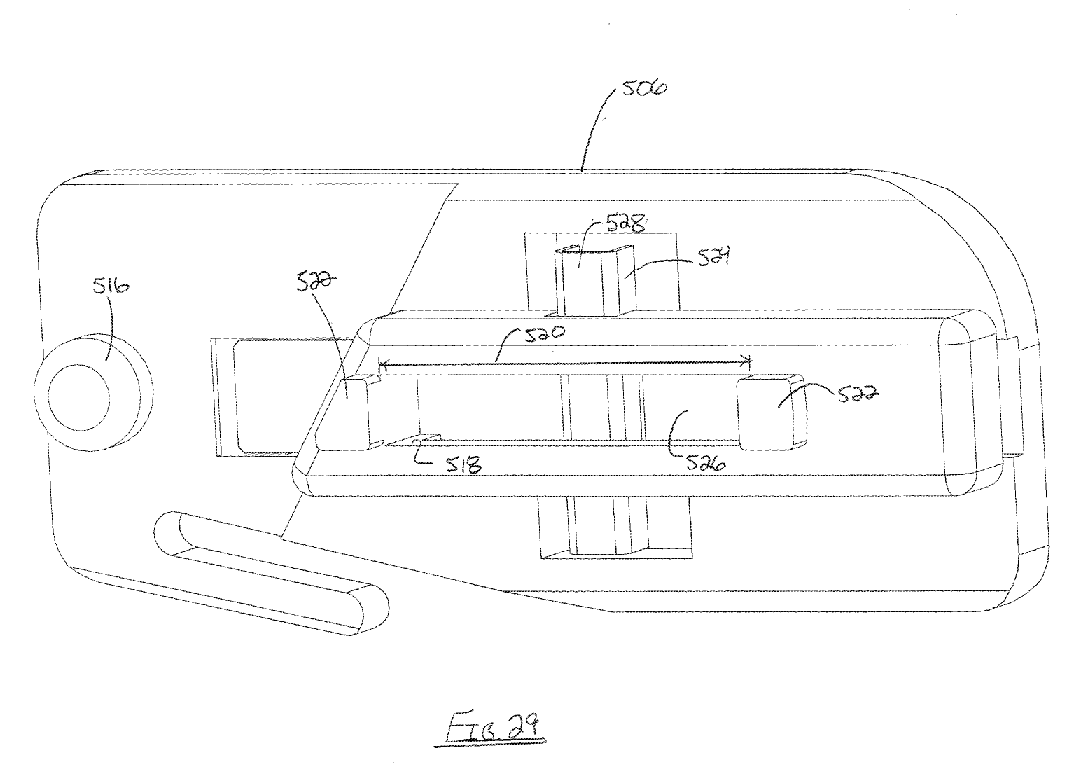

FIGS. 30-34 illustrate a knife 600 according to another embodiment of the invention. The knife 600 includes a handle 602, a frame 604, and a blade carrier 606 that positions a blade 608 relative to the handle 602 and the frame 604. The knife 600 further includes a locking assembly 610 that retains the blade carrier 606, and therefore the blade 608, in the desired position.

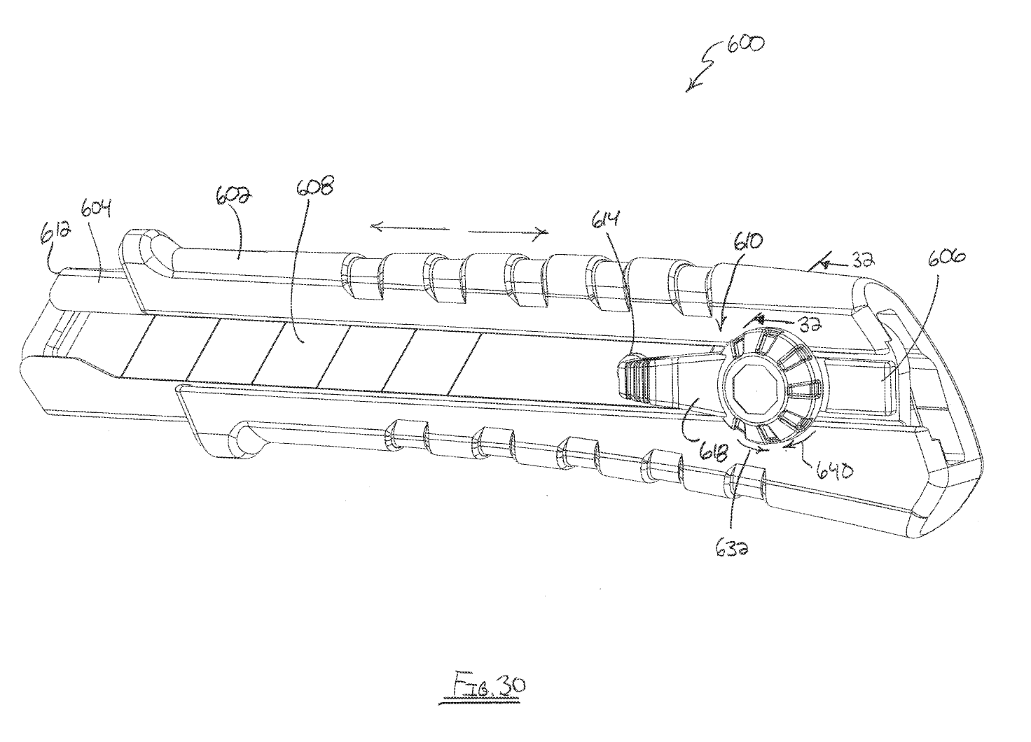

Referring to FIG. 31, the frame 604 includes a track 612 and the carrier 606 slides within the track 612 to position the blade 608 in the desired position. The carrier 606 includes a projection 614 (FIG. 30) that extends through the blade 608 to couple the blade 608 to the carrier 606.

The locking assembly 610 is coupled to the blade carrier 606 for movement with the carrier 606 along the track 612. Referring to FIG. 33, the illustrated locking assembly 610 includes an actuator 618, a bolt 620, a nut 622, a washer 624, a first biasing member 626, and a second biasing member 628. In the illustrated embodiment, the biasing members 626 and 628 are spring washers or Belleville washers.

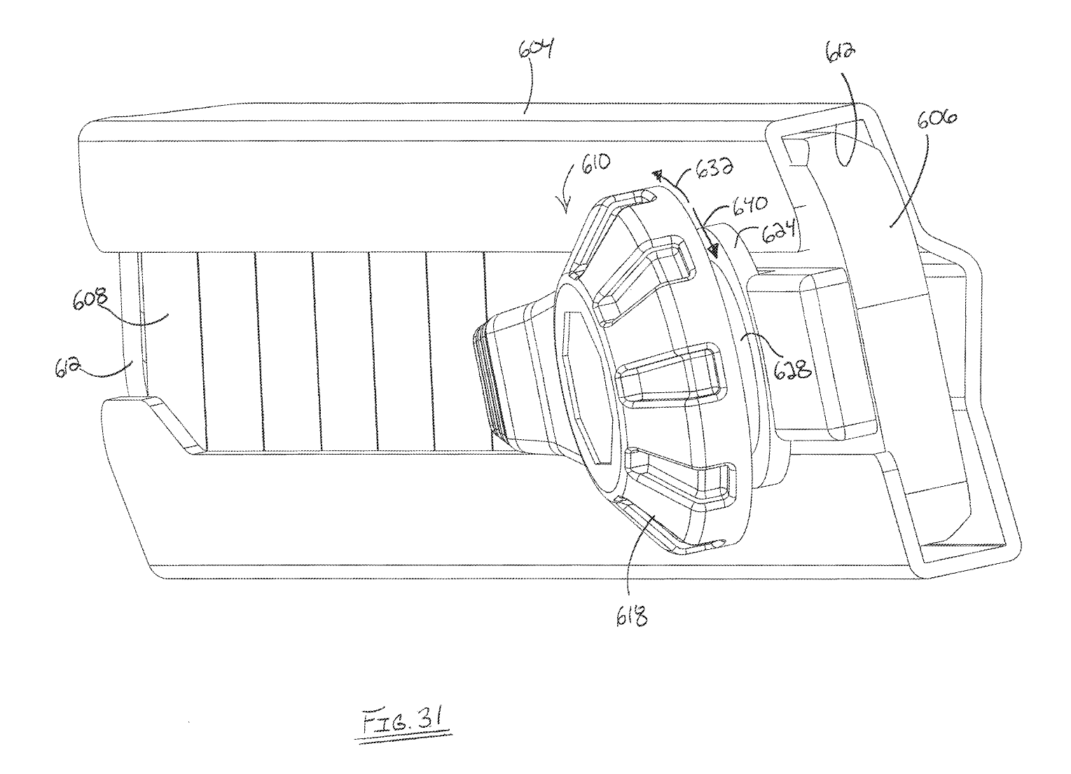

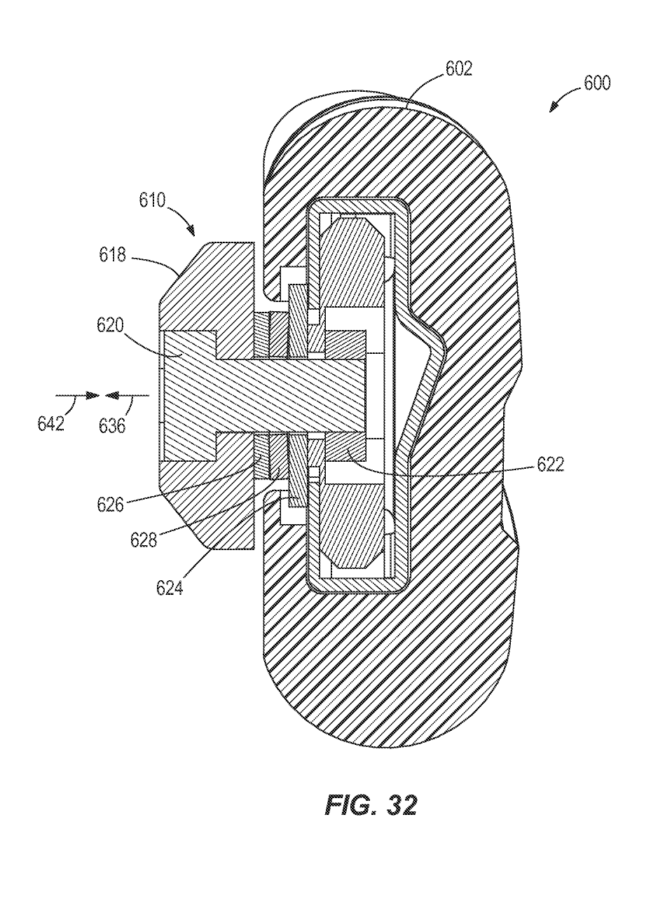

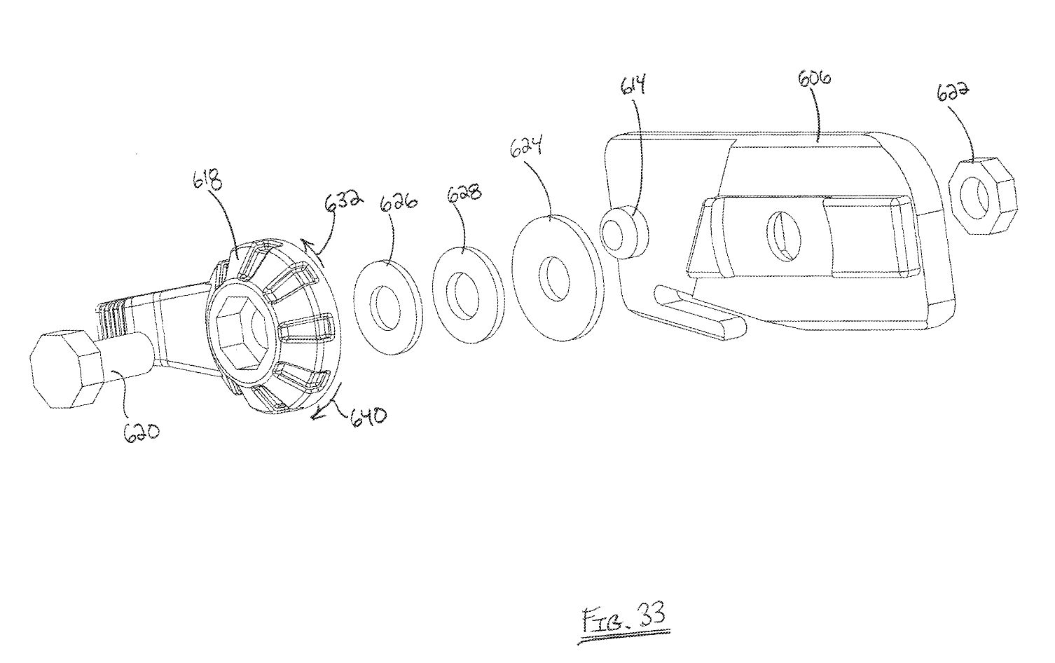

In operation, to position the carrier 606, and therefore the blade 608, relative to the frame 604, the user moves the locking assembly 610 from a locked position (FIG. 32) to an unlocked position. The move the locking assembly 610 to the unlocked position, the user rotates the actuator 618 in the direction of arrow 632, which causes the bolt 620 to rotate relative to the carrier 606 because the nut 622 is held from rotation with the respect to the carrier 606. As illustrated in FIG. 34, the nut 622 is held from rotation with respect to the carrier 606 because the nut 622 is received in a hex-shaped recess 634 of the carrier 606 that limits movement of the nut 622 relative to the carrier 606. Rotation of the bolt 620 in the direction of arrow 632 causes the bolt 620 to move away from the frame 604 and in the direction of arrow 636 of FIG. 32. This movement of the bolt 622 releases a clamping pressure that was being exerted on the washer 624 by the springs 626, 628 and the actuator 618. With the clamping pressure released, the user can move the carrier 606 and the blade 608 relative the frame 604 to a desired position.

When the blade 608 is in the desired position (e.g., extended or retracted), the user rotates the actuator 618 in the direction of arrow 640. Such rotation of the actuator 618 also rotates the bolt 620, which cases the actuator 618 to move in the direction of arrow 642 of FIG. 32 to exert a clamping pressure on the spring washers 626 and 628. The spring washers 626 and 628 then exert a clamping pressure on the washer 624. The friction between the washer 624 and the frame 604 caused by the clamping pressure in the direction of arrow 642 retains the carrier 606 and the blade 608 in the desired position.

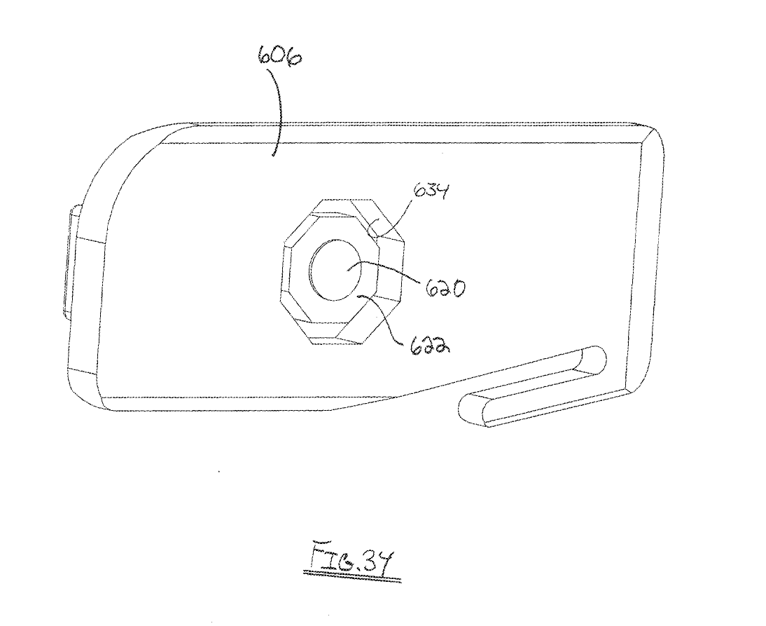

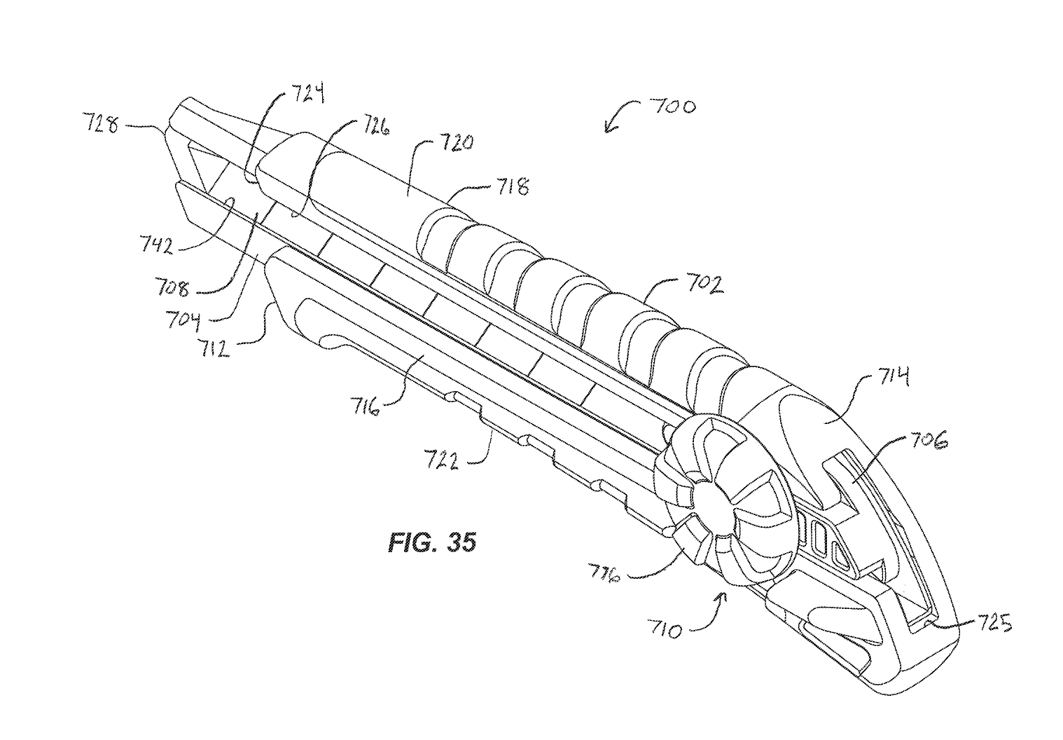

FIGS. 35-41 illustrate a knife 700 according to another embodiment of the invention. The knife 700 includes a handle 702, a frame 704, and a blade carrier 706 that positions a blade 708 in a desired position relative to the handle 702 and the frame 704. The knife 700 further includes a locking assembly 710 that retains the blade carrier 706, and therefore the blade 708, in the desired position.

With reference to FIG. 35, the handle 702 includes a front end 712, a back end 714, sidewalls 716 and 718 that extend from the front end 712 to the back end 714, and a top wall 720 and a bottom wall 722 that both extend from the front end 712 to the back end 714. The handle 702 is generally hollow and includes an opening 724 in the front end 712 through which the frame 704 and the blade 708 extend. The handle 702 also includes an opening 725 in the back end 714 through which the blade carrier 706 and the blade 708 may be removed to facilitate replacement of the blade 708. An elongated aperture 726 extends through the sidewall 716 between the front end 712 and the back end 714.

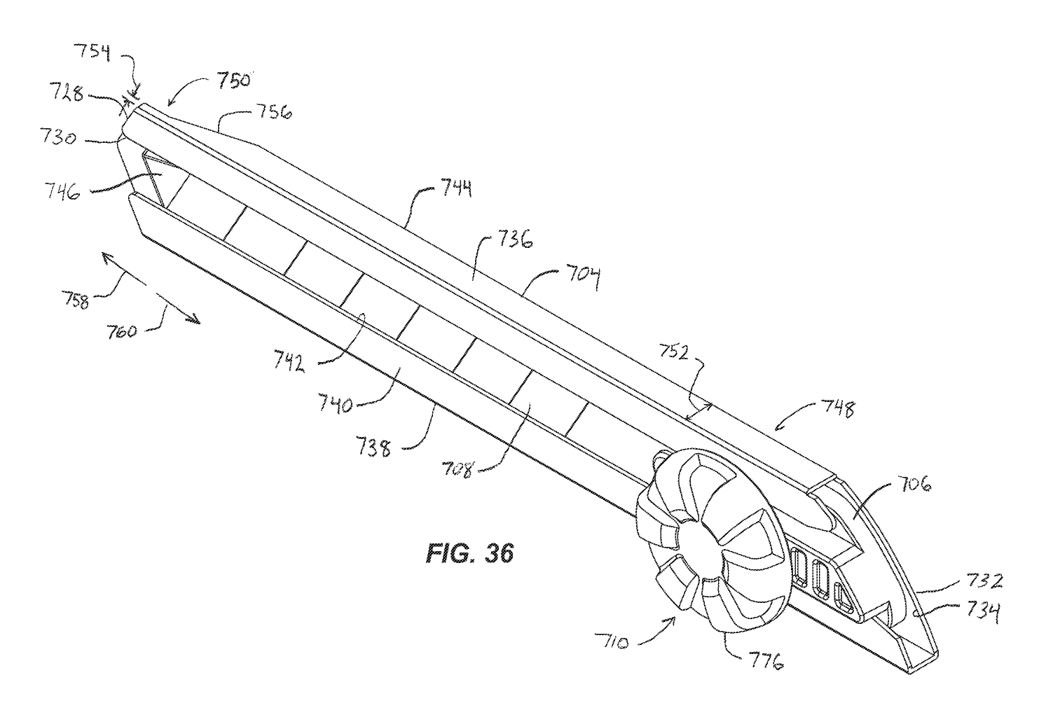

With reference to FIG. 36, the frame 704 includes a front end 728 that includes an opening 730 and a back end 732 that includes an opening 734. The frame 704 further includes a top wall 736 and a bottom wall 738 that both extend from the opening 730 at the front end 728 to the opening 734 at the back end 732. A first sidewall 740 of the frame 704 extends from the top wall 736 to the bottom wall 738, and the first sidewall 740 includes an elongated aperture 742 between the openings 730 and 734. The aperture 742 extends through the openings 730, 734. A second sidewall 744 extends from the top wall 736 to the bottom wall 738 opposite the first sidewall 740.

The frame 704 defines a track 746 that extends from the opening 730 at the front end 728 of the frame 704 and through the opening 734 at the back end 732 of the frame 704. The track 746 has a first portion 748 adjacent the back end 732 and a second portion 750 adjacent the front end 728 and the opening 730. The first portion 748 of the track 746 has a width 752 defined as the distance between sidewalls 740 and 744, and the second portion 750 of the track 746 has a width 754 that is less than the width 752. The reduced width 754 of the second portion 750 is created, at least in part, by an angled portion 756 of the first sidewall 740. The width 752 is sized to guide movement of the blade carrier 706 in the direction of arrows 758 and 760. The angled portion 756 of the first sidewall 740 is positioned to act as a stop to limit movement of the blade carrier 706 past the angled portion 756 in the direction of arrow 758 and prevent the blade carrier 706 from traveling through the opening 730 at the front end 728 of the frame 704.

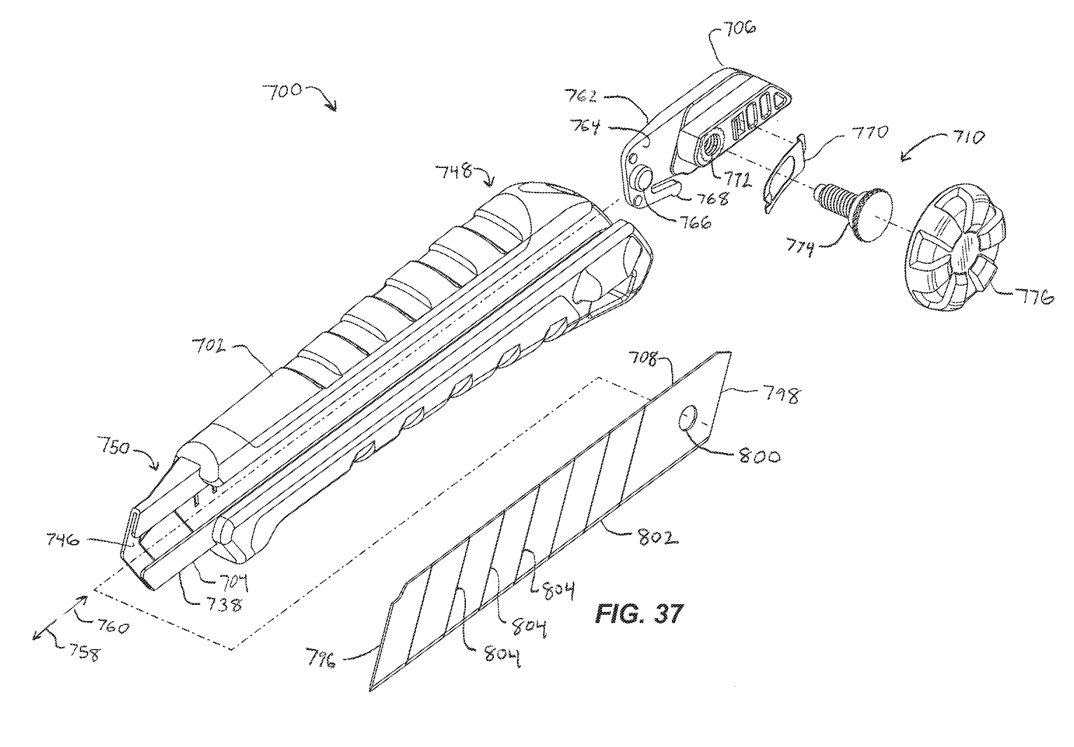

Referring to FIG. 37, the blade carrier 706 is received in the first portion 748 of the track 746 and the blade carrier 706 slides with respect to the frame 704 along the first portion 748 of the track 746 in the direction of the arrows 758 and 760. The blade carrier 706 includes opposing sides 762 and 764, a projection 766, a friction member 768, a leaf spring 770, and a threaded bore 772 extending through the blade carrier 706. The projection 766 extends from the side 764 and through the blade 708 to couple the blade 708 with the carrier 706 for movement with the carrier 706 with respect to the frame 704. The friction member 768 contacts the bottom wall 738 of the frame 704 to provide enough friction between the carrier 706 and the frame 704 to inhibit sliding movement of the carrier 706 along the track 746 caused by the force of gravity. Therefore, in the illustrated embodiment, a user must apply at least some force to the carrier 706, (e.g., via the locking assembly 710) to slide the carrier 706 along the track 746, and the force of gravity is insufficient to cause the carrier 706 to move in the direction of arrows 758 and 760 along the track 746.

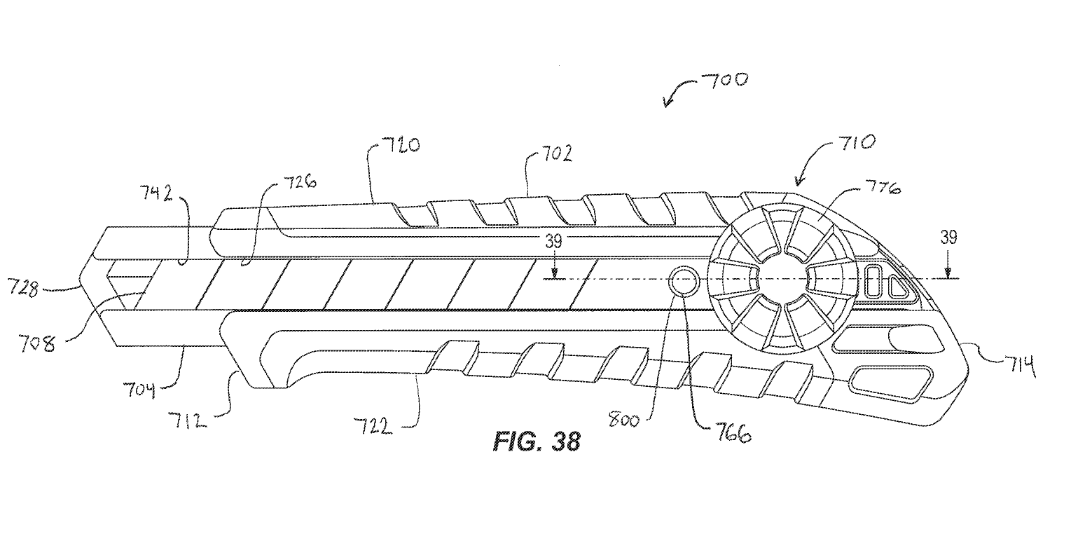

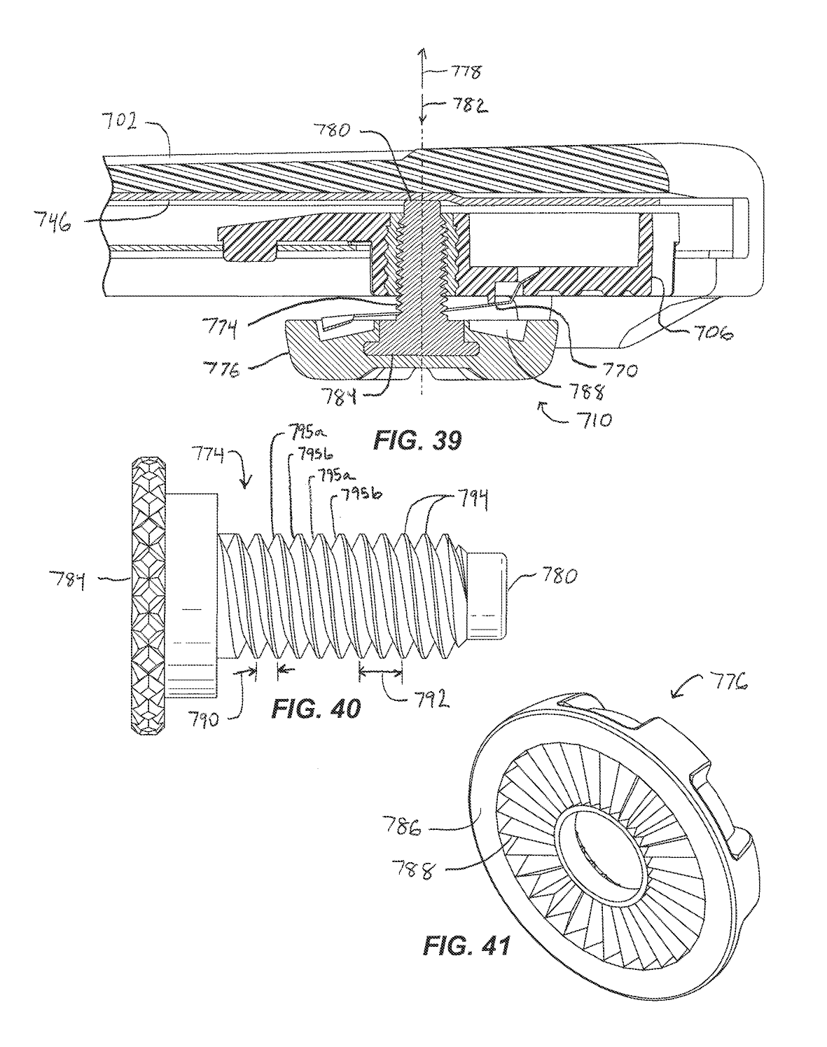

With continued reference to FIG. 37, the locking assembly 710 includes a fastener 774 and an actuator 776. With reference to FIG. 39, the fastener 774 is received within the threaded bore 772. The fastener 774 is rotatable relative to the blade carrier 706 to axially advance the fastener 774 in the direction of arrow 778, until a distal end 780 of the fastener 774 bears against the track 746, developing a clamping force between the fastener 774 and the track 746 to lock the blade carrier 706 in place. Similarly, the fastener 774 is rotatable relative to the blade carrier 706 to axially withdraw the fastener 774 in the direction of arrow 782 to disengage the distal end 780 of the fastener 774 from the track 746, permitting the blade carrier 706 to slide within the track 746. The actuator 776 is fixed to a proximal end 784 of the fastener 774 to facilitate rotation of the fastener 774 without the use of tools. Referring to FIGS. 35 and 38, the actuator 776 extends through the aperture 726 of the handle 702 and the aperture 742 of the frame 704 to provide the user with a place to grip the carrier 706 to slide the carrier 706 with respect to the frame 704 and the handle 702. In addition, with reference to FIGS. 39 and 41, the actuator 776 includes a rear side 786 having a plurality of ridges 788 that engage with the leaf spring 770 of the carrier 706 as the actuator 776 rotates. This engagement provides the user with a tactile sensation (e.g., clicking) when the user rotates the actuator 776.

Illustrated in FIG. 40, the fastener 774 defines a pitch distanced 790 (referred to hereafter as “pitch”) and a lead distance 792 (referred to hereafter as “lead”). The pitch 790 is the axial distance between adjacent crests 794 of the fastener 774. The lead 792 is the axial distance that the fastener 774 is advanced for each complete rotation of the fastener 774. A conventional threaded fastener (not shown) includes a single thread wrapped helically around the fastener. The pitch and the lead of the conventional fastener are equal; therefore the conventional fastener advances an axial distance equal to the pitch for each complete rotation. In the illustrated embodiment, the fastener 774 is configured as a double-lead screw (also referred to as a double-start screw or a double-threaded screw). The illustrated fastener 774 includes two separate threads 795a, 795b offset 180 degrees and wrapped helically around the fastener 744. As such, the fastener 774 advances twice the pitch 790 per rotation (i.e., the lead 792 is twice the pitch 790), thereby requiring less rotation to lock or unlock the blade carrier 706 than if a conventional fastener were used. In the illustrated embodiment, the fastener 774 is rotatable from the locked position to the unlocked position with an angular displacement of about 135 degrees or about ⅜ of a full rotation. In contrast, the conventional fastener would require an angular displacement of about 270 degrees, or about ¾ of a full rotation.

With reference to FIG. 37, the blade 708 includes a front end 796, a back end 798, and an aperture 800 adjacent the back end 798 that receives the projection 766 of the carrier 706 to couple the blade 708 to the carrier 706. A cutting edge 802 extends along the blade 708 from the front end 796 to the back end 798. Parallel score marks 804, which are parallel to the front end 796 and at an acute angle with respect to the cutting edge 802, are located between the ends 796 and 798. The score marks 804 allow the user to break the blade 708 along a score mark 804 if a portion of the cutting edge 802 between the score mark and the front end 796 becomes worn or dull.

In operation, to position the carrier 706, and therefore the blade 708, relative to the frame 704, the user moves the locking assembly 710 from a locked position (FIG. 39) to an unlocked position. To move the locking assembly 710 to the unlocked position, the user grips and rotates the actuator 776, which causes the fastener 774 to rotate relative to the carrier 706 and move away from the frame 746 in the direction of arrow 782. This movement of the fastener 774 releases a clamping pressure that was being exerted on the track 746 by the distal end 780 of the fastener 774. Because the fastener 774 is a double-lead fastener, the user need only rotate the actuator 776 by an angular displacement of about 135 degrees in a first direction (e.g., counterclockwise) to reach the unlocked position. This allows the user to move the locking assembly 710 from the locked position to the unlocked position in a single motion, without releasing the fastener 774. With the clamping pressure released, the user can grip the actuator 776 to move the carrier 706 and the blade 708 relative the frame 704 to a desired position.

When the blade 708 is in the desired position (e.g., extended or retracted), the friction member 768 (FIG. 37) of the carrier 706 provides enough friction against the track 746 to prevent movement of the carrier 706 along the track 746 from the force of gravity. The user then moves the locking assembly 710 to the locked position by gripping and rotating the actuator 776, which causes the fastener 774 to move in the direction of arrow 778 of FIG. 39. This movement of the fastener 774 develops a clamping pressure. The clamping pressure, developed by the engagement of the distal end 780 of the fastener 774 with the track 746, retains the carrier 706 and the blade 708 in the desired position. Because the fastener 774 is a double-lead fastener, the user need only rotate the actuator 776 by an angular displacement of about 135 degrees in a second direction (e.g., clockwise) to reach the locked position. This allows the user to move the locking assembly 710 from the unlocked position to the locked position in a single motion, without releasing the fastener 774.

To replace the blade 708, the user slides the carrier 706 through the back opening 734 of the frame 704 and through the aperture 725 in the back end 714 of the handle 702 to remove the carrier 706 and the blade 708 from the frame 704 and the handle 702. The user can then attach a new blade 708 to the carrier 706 and insert the blade 708 and the carrier 706 back through the aperture 725 at the back end 714 of the handle 702 and through the opening 734 in the back end 732 of the frame 704.

Various features of the invention are set forth in the following claims.

What is claimed is:

1. A utility knife comprising:
a frame defining a track;
a blade carrier slidably received within the track;
a blade removably coupled to the blade carrier;
an actuator operably coupled to the blade carrier to facilitate movement of the blade carrier along the track between an extended position and a retracted position;
a first handle portion coupled to the frame; and
a second handle portion coupled to the first handle portion, the second handle portion pivotable with respect to the first handle portion and the frame between a first position allowing movement of the blade between the retracted position and the extended position and a second position inhibiting movement of the blade between the retracted position and the extended position.

2. The utility knife of claim 1, further comprising a locking member pivotable from an unlocked position to a locked position in response to movement of the second handle portion from the first position to the second position.

3. The utility knife of claim 2, wherein the blade carrier includes a recess formed in a side of the blade carrier opposite the actuator.

4. The utility knife of claim 3, wherein the locking member includes a projection selectively engageable with the recess of the blade carrier in the locked position of the locking member.

5. The utility knife of claim 3, wherein the recess is one of a plurality of recesses formed in the side of the blade carrier opposite the actuator, and wherein the projection is one of a plurality of projections selectively engageable with the plurality of recesses in the locked position of the locking member.

6. The utility knife of claim of claim 2, wherein the second handle portion includes a first actuating surface and the locking member includes a second actuating surface engageable with the first actuating surface as the second handle portion moves from the first position to the second position.

7. The utility knife of claim 6, wherein sliding engagement between the first actuating surface and the second actuating surface induces pivotal movement of the locking member between the unlocked position and the locked position.

8. The utility knife of claim 2, wherein the locking member includes a biasing member operable to bias the locking member towards the unlocked position.

9. The utility knife of claim 8, wherein the biasing member is a first biasing member, and wherein the locking member includes a second biasing member operable to bias the locking member towards the unlocked position.

10. The utility knife of claim 8, wherein the biasing member is operable to bias the second handle portion towards the first position.

11. The utility knife of claim 9, wherein the first biasing member and the second biasing member are operable to bias the second handle portion towards the first position.

12. The utility knife of claim 1, wherein the blade carrier includes a friction member to inhibit sliding movement of the carrier along the track.

13. The utility knife of claim 1, wherein the first handle portion includes an elongated aperture and the actuator extends through the aperture.

14. The utility knife of claim 1, wherein the frame includes an elongated aperture and the actuator extends through the aperture.

15. The utility knife of claim 1, wherein the second handle portion includes a contoured surface configured to be gripped by a user during operation of the utility knife.

16. The utility knife of claim 1, wherein the frame includes a front opening and a rear opening, the track extending between the front opening and the rear opening.

17. The utility knife of claim 17, wherein the track includes a first region defining a first width and a second region proximate the front opening, the second region defining a second width less than the first width.

18. The utility knife of claim 18, wherein the blade carrier is slidable within the first region of the track, and wherein the blade carrier is prevented from sliding within the second region of the track.

19. The utility knife of claim 17, wherein the track includes an angled transition region between the first region and the second region.

20. The utility knife of claim 1, wherein the blade is a segmented blade.

21-31. (canceled)
